(19) United States
(12) Patent Application Publication
(10) Pub. No.: US 2026/0304231 A1
(43) Pub. Date: Oct. 1, 2026

(54) TRUST-AWARE GROUP FORMATION FOR 6G TASK-SPECIFIC REQUEST (TSR) PROCESSING

(71) Applicant: InterDigital Patent Holdings, Inc., Wilmington, DE (US)

(72) Inventors: Xu Li, Plainsboro, NJ (US); Chonggang Wang, Princeton, NJ (US); Robert Gazda, Spring City, PA (US); Samir Ferdi, Kirkland (CA); Ulises Olvera-Hernandez, Saint-Lazare (CA); Rocco Di Girolamo, Laval (CA); Michel Roy, Candiac (CA)

(73) Assignee: InterDigital Patent Holdings, Inc., Wilmington, DE (US)

(21) Appl. No.: 19/092,645

(22) Filed: Mar. 27, 2025

(51) Int. Cl. H04W 28/18

(52) U.S. Cl. CPC H04W 28/18

(57) ABSTRACT

A method performed by a NF may comprise: receiving, from a TSR sender, a first request message including a TSRP of a task, wherein the task include one or more TSRs for processing by one or more TPs and wherein the TSRP indicates a TL-TR needed for processing the one or more TSRs; determining one or more candidate TPs; transmitting, to the one or more candidate TPs, a second request message including a request to process the one or more TSRs; receiving, from at least one of the one or more candidate TPs, a first response message including a TSR-PWP and a trust declaration; based on one or more trust declarations associated with the one or more candidate TPs, determining a FTPG; determining, based on the FTPG, one or more TSR sending policies; and transmitting, to the TSR sender, the one or more TSR sending policies.

### BACKGROUND

In sixth-generation (6G) networks, wireless transmit/receive units (WTRUs), devices, and entities (collectively defined as task participants (TPs), may perform various tasks to enable native 6G system features or support complex 6G vertical applications. A task specifies a particular type of operation that a TP must perform, such as computing-related, communication-related, sensing-related, or a combination of these. The execution of a task by a TP (i.e., performing the required operations) may be triggered by the receipt of task-specific requests (TSRs).

An example of a task within the context of a 3GPP system is the execution of a ProSe WTRU-to-Network relay (e.g., UE-to-Network relay). A ProSe WTRU-to-Network relay may function as a TP, facilitating indirect communication between the network and remote WTRUs that are outside network coverage (which act as TSR senders). For instance, a WTRU that is out of network coverage (i.e., a TSR sender) may transmit a request (i.e., a TSR) to the ProSe WTRU-to-Network relay WTRU (acting as a TP). This TSR may include a payload intended for a network function (NF) in the core network. Upon receiving the TSR, the ProSe WTRU-to-Network relay is triggered to perform the relay operation, forwarding the payload to the core network via a nearby base station.

### SUMMARY

A method performed by a network function (NF) may comprise: receiving, from a task-specific request (TSR) sender, a first request message including a TSR profile (TSRP) of a task, wherein the task include one or more TSRs for processing by one or more task participants (TPs) and wherein the TSRP indicates task-level trust requirement (TL-TR) needed for processing the one or more TSRs; determining one or more candidate TPs, wherein the one or more candidate TPs have capabilities to process one or more TSRs included in the TSRP; transmitting, to the one or more candidate TPs, a second request message including a request to process the one or more TSRs; receiving, from at least one of the one or more candidate TPs, a first response message including a TSR-processing workload proposal (TSR-PWP) and a trust declaration; based on one or more trust declarations associated with the one or more candidate TPs, determining a formal TP group (FTPG); determining, based on the FTPG, one or more TSR sending policies; and transmitting, to the TSR sender, the one or more TSR sending policies.

The method may further comprise determining a tentative TP group (TTPG) based on the TSR-PWP, wherein the TTPG includes at least one of the one or more candidate TPs and is based on a trust potential declaration from at least one of the one or more candidate TPs; transmitting, to a distributed ledger function (DLF), a third request message, including a trust endorsement discovery request; and receiving, from the DLF, a second response message, including one or more trust endorsements associated with the one or more candidate TPs of the TTPG. The FTPG may be determined from the TTPG based on the more or more trust endorsements of the one or more trust declarations and the third request message may include a trust endorsements discovery filter criteria.

The NF may be a group formation assistant function (GFAF) and the TSR may be a WTRU. The TSR-PWP may indicates a workload assignment proposal. The TSRP may include one or more TSR-categories (TSR-Cs) and the one or more TSR-Cs may include at least one of a TSR-C identification, a TSR workload description, a TSR trust requirement, and/or a TSR-C importance score.

A method performed by a TSR sender may comprise: generating one or more TSRs, wherein the TSRs are included in a task; generating a TSR profile of the task; transmitting, to a NF, the TSRP; receiving, from the NF, one or more TSR sending policies; transmitting a discovery request message to one or more TPs, wherein the TPs are part of a FTPG; based on the one or more TSR sending policies, transmitting, to the one or more TPs, the one or more TSRs. The TSR sender may be one of a wireless transmit/receive unit (WTRU), an application function (AF), and/or an application server (AS).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example task and task specific request (TSR) processing procedure;

FIG. 3 illustrates an example workflow of a blockchain system;

FIG. 4 illustrates an example procedure for task participant (TP) registration;

FIG. 5 illustrates an example procedure for trust-aware TP group formation;

FIG. 6 illustrates an example of a TSRP of a task;

FIG. 7 illustrates an example procedure for trust-aware TP group formation;

FIG. 8 illustrates an example procedure for trust-aware TP group formation where the TSR sender is an application function (AF) or application service (AS);

FIG. 9 illustrates an example procedure for trust-aware TP group formation in a non-3GPP network;

FIG. 10 illustrates an example procedure for trust-aware TP group formation; and

FIG. 11 illustrates an example procedure for trust-aware TP group formation.

### DETAILED DESCRIPTION

The following acronyms and abbreviations may be referred to:
3D Three Dimensional
3rd Generation Partnership Project
5G 5th Generation
5GC 5G Core Network
5GS 5G System
6G 6th Generation
6GC 6G Core Network
6GS 6G System
AF Application Function
AI Artificial Intelligence
AMF Access and Mobility Management Function
API Application Programming Interface
AR Augmented Reality
AS Application Server
BCN Blockchain Nodes
CM Connection Management
DDNMF Direct Discovery Name Management Function
DN Data Network
DLF Distributed Ledger Function
DLT Distributed Ledger Technology
E2E End-to-End
ETSI European Telecommunications Standards Institute
FL Federated Learning
FQDN Fully Qualified Domain Name
FTPG Formal TP Group
GenAI Generative AI
GFAF Group Formation Assistance Function
GMLC Gateway Mobile Location Centre
IMEI International Mobile Equipment Identity
IP Internet Protocol
ISG Industry Specification Group
ML Machine Learning
MNO Mobile Network Operator
NEF Network Exposure Function
NF Network Function
NG-RAN Next-Generation RAN
NRF Network Repository Function
NW Network
P2P Peer-to-Peer
PCF Policy Control Function
PDU Protocol Data Unit
ProSe Proximity-based Service
RAN Radio Access Network
RM Registration Management
SA Service Architecture
SBA Service Based Architecture
SBI Service-based Interface
SC Smart Contract
SEAL Service Enabler Architecture Layer
SMF Session Management Function
SUCI Subscription Concealed Identifier
TL-TR Task Level-Trust Requirement
TMF Trust Management Function
TP Task Participant
TSR Task-Specific Request
TSR-C Task-Specific Request Category
TSRP TSR Profile
TSR-PWP TSR-Processing Workload Proposal
TTPG Tentative TP Group
UDM Unified Data Management
UDR Unified Data Repository
UE User Equipment
UPF User Plane Function
URL Uniform Resource Locator
VAL Vertical Application Layer
XR Extended Reality

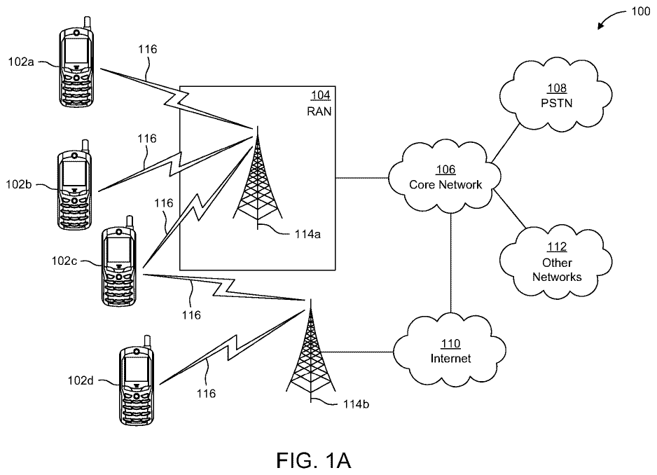

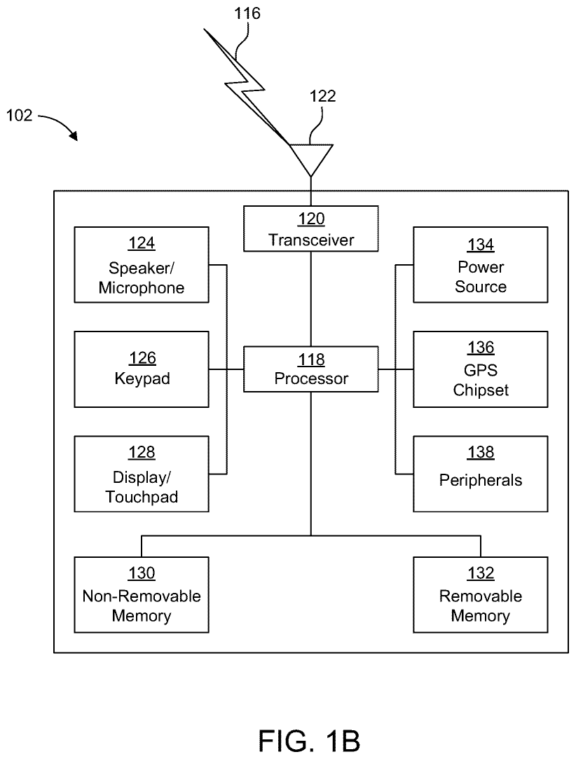

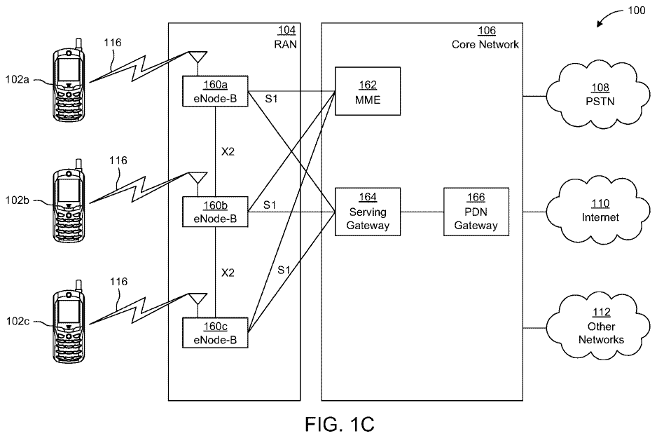

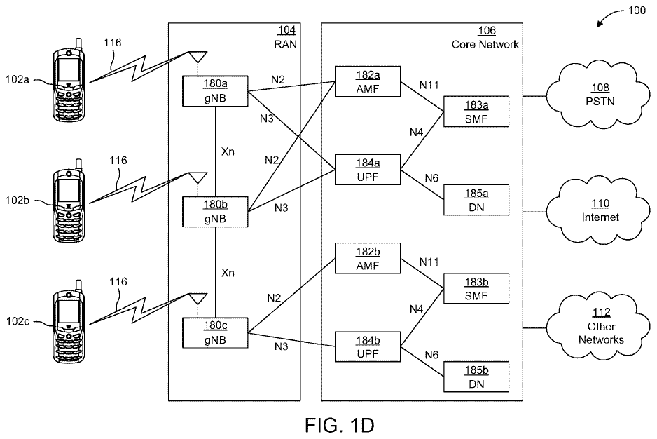

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Hereinafter, it a Distributed Ledger Function (DLF) exists within the system. The DLF may manage distributed ledgers that record trust. potential declarations made by TPs and trust endorsements submitted by trust endorsers, such as TSR senders or the Trust Management Function (TMF). The DLF and TMF may be considered separate entities, but alternatively, the DLF may be implemented within the TMF.

Hereinafter, the Group Formation Assistant Function (GFAF) is a newly introduced function designed to facilitate the formation of a TP group, enabling collaborative processing of TSRs for a given task and achieving the task-level trust requirement (TL-TR). The GFAF may be implemented within a wireless system as a Network Function (NF), an Application Function (AF), a service enabler server, or another suitable system component.

Hereinafter, it is assumed that a Formal TP Group (FTPG) may be formed when the Group Formation Assistant Function (GFAF) transforms a Tentative TP Group (TTPG) into an FTPG. This transformation occurs if two conditions are met: (1) every Task-Specific Request (TSR) associated with a task, as outlined in the TSR Profile (TSRP), can be served by at least one candidate TP in the TTPG, and (2) the TL-TR, as specified in the TSRP, may be achieved based on trust potential declarations made by TPs, which have been validated by credible trust endorsements.

Hereinafter, a task may define the specific type of operation that needs to be performed by a TP or a group of TPs. These operations may include, but are not limited to, computing-related, communication-related, sensing-related, storage-related, mixed operations, or any other possible functions required for task execution.

Hereinafter, a trust endorsement may describe the historical trust performance of a TP or a group of TPs based on one or more trust indicators, such as security, scalability, availability, reliability, etc. for processing TSRs associated with a past task. Trust performance on a trust indicator may refers to how well a TP has performed in that aspect. Trust endorsements may be recorded in distributed ledgers or other storage systems to serve as valuable references for estimating a TP's trustworthiness for processing TSRs of a new or ongoing task. These endorsements support the trust potential declarations made by TPs and may be issued by various stakeholders or endorsers, such as a TSR sender or a TMF managed by a mobile operator. Trust endorsements from reputable endorsers, such as an operator-owned TMF, may be considered more credible than those from individual TSR senders.

Hereinafter, a task participant (TP) may be an entity that performs TSR processing within various distributed 6G applications or system features. Multiple TPs may undertake different tasks, receiving TSRs from TSR senders, processing them, and returning the corresponding results.

Hereinafter, a trust potential declaration may be made when a TP expresses its capability and intent to undertake TSR processing for specific tasks. For example, a TP may declare, “I can be a highly secure TP (e.g., security score>90) for processing TSRs of a specific task.” These declarations may communicate the TP's confidence in meeting the trust-related expectations set for a given task.

Hereinafter, a trust requirement may represent the specific trust-related criteria that different TSR-Categories (TSR-Cs) may impose on TPs for TSR processing. A TSR-C trust requirement specifies the necessary trust-related performance standards a TP must achieve for processing TSRs associated with a particular TSR-C. This requirement may include: (1) a list of relevant trust indicators (e.g., security, scalability, etc.) and (2) a detailed description of the expectation (e.g., TSRs in a given TSR-C must be processed by TPs with a security score exceeding 95). The aggregation of trust requirements across different TSR-Cs within a task defines the TL-TR.

Hereinafter, a Task-Specific Request (TSR) may represent an actionable unit within a task, meaning that executing a task typically requires processing multiple TSRs. The execution of a task may be performed by a TP or a group of TPs, who conduct the necessary operations in response to received TSRs.

Hereinafter, a TSR Profile (TSRP) may provide a structured description of a task's TSRs, including parameters such as TSR schedule, pattern, workload, size, and associated trust requirements for TSR processing.

Hereinafter, a TSR-Category (TSR-C) may group TSRs within a task that share similar characteristics, such as pattern, size, and complexity, as well as the same trust requirements. TSRs that fall into the same TSR-C are treated similarly in terms of processing and trust evaluation.

Hereinafter, a TSR sender may be an entity that initiates or generates TSRs for a task. To process received TSRs, TPs may execute the required task-specific operations, which may involve computing, communication, sensing, or mixed functionalities.

Hereinafter, a Tentative TP Group (TTPG) may be formed by the GFAF when it receives TSR-Processing Workload Proposals (TSR-PWPs) from multiple TPs. A TTPG may be established if at least two conditions are met: (1) at least one candidate TP within the TTPG may serve each TSR of the task as defined in the TSRP, and (2) the TL-TR specified in the TSRP has the potential to be met based on the trust potential declarations made by TPs. However, in the TTPG stage, these trust potential declarations have not yet been supported by credible trust endorsements.

Hereinafter, a TL-TR may represent the aggregated trust requirements across all TSR-Cs within a task. The overall success and quality of the task depend on meeting its TL-TR rather than just satisfying individual TSRs.

Hereinafter, a TSR-Processing Workload Proposal (TSR-PWP) may be a submission made by a TP to the GFAF in response to a task's TSRP. The TSR-PWP may indicate: (1) which portion of the TSR processing workload the TP is willing to undertake and (2) one or more trust potential declarations made by the TP to meet the trust requirements described in the TSRP.

In 6G networks, WTRUs, devices, and entities (collectively defined as TPs), may perform various tasks to enable native 6G system features or support complex 6G vertical applications. A task may specify a particular type of operation that a TP must perform, such as computing-related, communication-related, sensing-related, or a combination of these. The execution of a task by a TP (i.e., performing the required operations) may be triggered by the receipt of one or more TSRs.

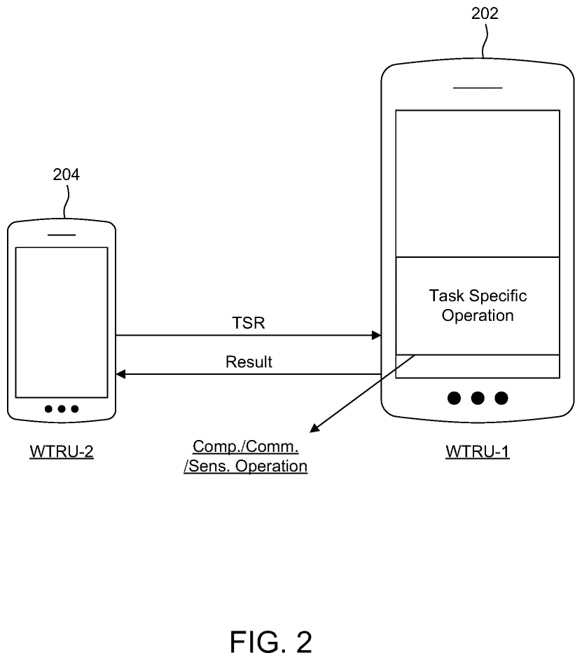

FIG. 2 illustrates an example of task and TSR processing. A shown in FIG. 2, WTRU-1 202 (acting as a TP in this scenario) may receive one or more TSRs of a task from WTRU-2 204 (acting as a TSR sender in this scenario. In order to process the received TSRs, WTRU-1 202 may execute the desired task-specific operations. After executing the task-specific operations, WTRU-1 202 may return the TSR processing result to WTRU-2 204.

An example of a task within the context of a 3GPP system is the execution of a ProSe WTRU-to-Network relay (e.g., UE-to-Network relay). A ProSe WTRU-to-Network relay may function as a TP, facilitating indirect communication between the network and remote WTRUs that are outside network coverage (which act as TSR senders). For instance, a WTRU that is out of network coverage (i.e., a TSR sender) may transmit a request (i.e., a TSR) to the ProSe WTRU-to-Network relay WTRU (acting as a TP). This TSR may include a payload intended for a network function (NF) in the core network. Upon receiving the TSR, the ProSe WTRU-to-Network relay is triggered to perform the relay operation, forwarding the payload to the core network via a nearby base station.

The term “trust” may refer to a measurable belief that represents an accumulated value (e.g. about the quality, behavior, performance, and/or characteristic of a network node, a WTRU, a service or any logical/physical entity) from history and the expected value for the future. Trust may be an objective trust or a subjective trust. An objective trust may leverage the security mechanism, such as authentication, to validate an entity's identity. However, trust covers and is beyond security. For example, an entity passing the authentication may indicate that the entity has successfully proved its identity, but it still may not be fully trusted since the trust about the entity's behavior/characteristics may still be dynamically changing and the criteria for evaluating trust may also be subjective (e.g. based on user/personal experience/preference). Trust is an input for decision making and may be measured or calculated based on the history experience/records in the past, and it represents the expected value of quality, behavior, characteristics, and/or performance in the future.

Different stakeholders may have subjective criteria regarding how the trust of an entity should be evaluated. For example, trust may be evaluated by evaluating one or more trust indicators, which may cover various aspects, such as security, privacy, resilience, performance, robustness, scalability, availability, accuracy, reliability, consistency, etc. In the meantime, an entity may have different levels of trust for executing different types of tasks/operations. For example, an entity may be a highly-secure entity for performing communication-related operations, but may be an unsecure entity for performing computing-related operations, etc.

A trust level may be reflected as a trust score, a trust index, or any other metric value. The trust level may be derived via a trust evaluation process. The trust evaluation may be conducted by various stakeholders. For example, in an interaction between a service producer and a service consumer, the producer and consumer may conduct trust evaluations mutually to determine the trust metric/score/index of the counterpart, and further decide whether the counterpart can be trusted or not. Alternatively, the service producer or service consumer may also rely on an external or 3rd party authority to conduct trust evaluation. For example, a TMF may act as an authority to conduct trust evaluation on service producer and consumers and derive trust metric/score/index of producer/consumer.

While trust relates to security, it may go beyond just security. For example, authentication and authorization may be the security mechanisms that enable trust in telecom networks but trust may be more than authentication. There are various 3GPP 5G security functions in place across different domains. For example, security for network access focuses on security aspects between WTRU and RAN/CN, network domain security focuses on security mechanisms between RAN and CN and SBA domain security focuses on secure communication between various NFs in CN. For example, network access security contains mechanisms such as network access authentication, which further includes primary authentication and key agreement, and secondary authentication. In addition, certain wireless standards study enablers for zero-trust security in a 5G System by investigating several key issues, including the types of data exposure that are necessary to enable security evaluation, monitoring, etc.

Distributed ledger technology (DLT) is a digital system that includes advanced features such as decentralization, immutability, transparency, and security. Distributed ledgers can simultaneously record digital transactions or any other important information across multiple nodes in a DLT network by leveraging a number of different technologies such as cryptography, hashing, Merkle tree, Peer-to-Peer (P2P) networking, and consensus protocols. Blockchain technology is a special type of distributed ledger.

In a blockchain system, blockchain nodes are connected via P2P links and form a mesh P2P network, over which transactions and blocks are broadcasted among all blockchain nodes. A blockchain node may connect to multiple other blockchain nodes as its neighbors or neighboring blockchain nodes. Applications using and/or supported by a blockchain system are referred to as blockchain applications. A blockchain system is underpinned by underlying blockchain networks which are composed of many participating blockchain nodes. Each blockchain node hosts one or more blockchains (a form of distributed ledgers) and participates in the blockchain system. For example, blockchain nodes broadcast blockchain transactions and blocks among each other using peer-to-peer networking; blockchain nodes also perform consensus protocols with each other to reach distributed trust and consensus without relying on a centralized party. A blockchain transaction could be a digital representation of a real-world transaction, a digital record of physical assets, a digital record of a physical event, a digital record of any action in an information system, a digital payment, and/or a digital smart contract; a block groups multiple blockchain transactions together.

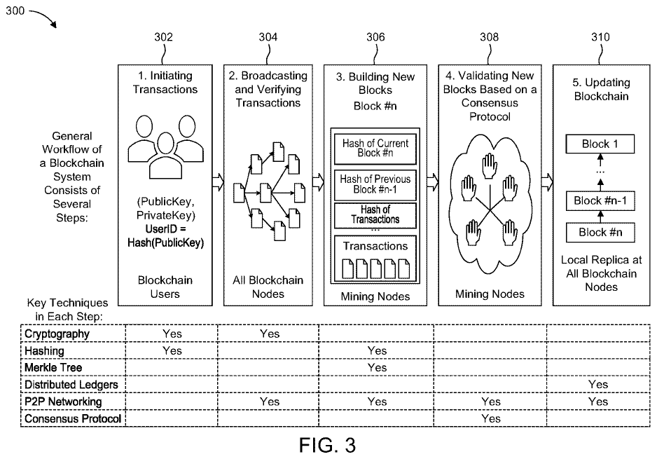

FIG. 3 illustrates an exemplary workflow 300 of a blockchain system. As shown in FIG. 3, an exemplary workflow may include five steps.

Step 302 includes initiating transactions. At 302, each participating user independently generates new transactions. Each user may have a user identifier or account identifier, which may be a hash of the user's public key. Each new transaction may be signed using the user's private key. After a new transaction is generated, the user may send the transaction to the blockchain network.

Step 304 includes broadcasting and verifying the transactions. At 304, a new transaction may be first received by some blockchain nodes, which will verify its integrity using the user's public key, which is included in the transaction. After the verification and if the new transaction is valid, it will be relayed and broadcasted within the blockchain network. Eventually, all blockchain nodes will receive and have a copy of any newly generated and valid transactions.

Step 306 includes building new blocks. At 306, some blockchain nodes (referred to as Mining Nodes or Full Nodes) start to group multiple newly generated and pending transactions together to generate a new block. The new block may include of a block header and a block body. The block header may include a hash of the current block, a hash of the previously-confirmed block (e.g. the last block on an existing blockchain), and a hash of all included transactions (e.g. Merkle tree). Depending on the consensus protocol, the block header may contain additional information. The block body contains the content of all included transactions. Each mining node independently attempts to create a new block.

Step 308 includes validating new blocks based on a consensus protocol. At 308, mining nodes independently attempt to create a new block. The mining nodes run the same consensus protocol (e.g., Proof-of-Work in a Bitcoin system) and reach an agreement on who (i.e., a winner) is allowed to insert a block into the existing blockchain. The winner of the consensus protocol will send its newly generated block to the blockchain network. This new block will be broadcasted and let all mining nodes receive it and verify it.

Step 310 includes updating the blockchain. After the newly generated block is verified, it is successfully appended to the existing blockchain, since it contains a hash of the previous block (i.e., the last block of the existing blockchain).

In 6G cellular networks, WTRUs and other devices may function not only as service consumers but also as providers of services and/or resources (e.g., communication, computing, sensing, storage, etc.) to other WTRUs, NFs, and AFs or ASs. A WTRU or device may act as a TP for conducting various communication/computing/sensing/storage operations. Future 6G applications or 6G native system features may be realized in a fully distributed way (i.e., multiple WTRUs (as TPs) may be assigned different tasks so that those WTRUs work together to realize a 6G application or a 6G system feature). Any existing/future system feature or vertical application may be modeled using the concepts/terms adopted in this disclosure (such as task, TSR, TSR sender, TP) of task and a few use cases in the context of 3GPP system are listed below.

In one use case, a ProSe WTRU-to-NW relay WTRU (acting as a TP) may provide relay service (i.e., a task) to a remote WTRU (acting as a TSR sender), which may send TSRs (containing data payloads to be uploaded to core network) to the ProSe WTRU-to-NW relay WTRU. Although existing wireless system already defined the basic mechanisms for supporting ProSe operations such as WTRU-to-NW relay service, how to provide “trustworthy” ProSe communication services has not been defined in 5G. Further, how to form a WTRU-to-NW relay group to provide a trustworthy WTRU-to-NW replay service for a remote WTRU has not been addressed in any existing work and is the focus of this disclosure.

In another use case, AR device X (acting as a TSR sender) is running an AR-related application but short of computing resources for AR processing. AR device X may send an AR workload offloading request (i.e. as a TSR) to another AR device Y (acting as a TP) so that the AR device Y may help in conducting complex operations required by an AR task (such a split video rendering).

In another use case, an AF in a data network or a NF in the core network (acting as a TSR sender) may send a TSR to a WTRU (acting as a TP for performing a sensing task) in a specific geographical area in order to ask the WTRU to capture desired sensory information from the physical world using WTRU's on-board sensing capabilities.

In another use case, an AI Agent (such as a TP) in the 3GPP system can provide Generative AI related services to an AI Agent consumer (such as a TSR sender). For example, an AI agent consumer may be a WTRU, which can send a Generative AI service request to an AI agent, which can process the request and return the TSR processing result (e.g. the generated AI contents).

This description considers a volatile environment in which WTRUs/devices (acting as TPs) may not belong to the same trust domain, may display unpredictable behavior or performance when carrying out task-specific operations, or may not operate as commercial resource or service providers with an assumed level of trust. In contrast, companies or commercial providers are generally trusted based on their established reputations. Examples of TPs in such environments include personal smartphones, AR/VR devices, and personal or shared vehicles in a city.

However, the trust of TPs plays a key role that may impact the overall success/quality of the task. For example, an untrusted TP may process TSRs in an undesired manner (e.g. less secure, unscalable, low availability, etc.) and bring unsatisfactory user experience to the TSR senders. Therefore, when a TSR sender intends to send related TSR(s) to a TP for processing, the TSR sender (or other stakeholders) may specify trust-related requirement(s) on TP(s) for TSR processing. For example, one requirement may be that a TSR sender requires that the TSRs should only be processed by the TP having excellent performances on one or more focused trust indicators (e.g., security, availability, scalability, etc.).

Another observation is that a task may involve multiple TSRs to be processed but those TSRs may be associated with diverse trust requirements.

In one example, where diverse trust requirements exist across TSRs initiated by different TSR senders, Task-1 may require WTRU-2 (acting as a TP) to perform WTRU-to-NW relay operations. The TP may serve multiple Remote WTRUs (e.g., WTRU-1 and WTRU-3), which act as TSR senders. For instance, WTRU-1 may require that all its TSRs be processed by WTRU-2 with a high level of security (i.e., the WTRU-to-NW relay operation must be highly secure), indicating that WTRU-1 considers the security of WTRU-2 as the most critical trust indicator for TSR processing. In contrast, WTRU-3 may require that all its TSRs be processed by WTRU-2 with the highest possible speed (i.e., the WTRU-to-NW relay operation must be highly scalable), signifying that WTRU-3 prioritizes the availability and responsiveness of WTRU-2 as the key trust indicator for TSR processing.

In another example, where diverse trust requirements across TSRs are initiated by the same TSR sender, even for the TSRs initiated by the same TSR sender, they may be associated with different trust requirements. Taking the previous example, WTRU-1 has 100 TSRs to be processed. WTRU-1 poses a trust requirement indicating that the first 50 TSRs should be processed by WTRU-2 in a highly-secure way while the second 50 TSRs should be processed by WTRU-2 in a highly-scalable way.

However, within 6G system deployments, not all trust requirements of TSRs may be fully met by a single TP (which could be any physical or logical entity such as a WTRU, a RAN node, a NF, or a AF/AS, etc.), for example, due to TPs'limited capability or capacities, context (e.g., such as location), access to data, etc. For example, different TSRs may be associated with diverse trust requirements and different levels of importance. The trust requirement(s) of critical TSRs have been met but the trust requirement of non-critical TSRs have not been met at all.

Furthermore, the overall success/quality of task does may not depend on whether the processing of a single TSR can meet its trust need, but whether the TL-TR can be met, which are the aggregated trust requirements across all the TSRs associated with the same task. In a 6G system, a single TP may not have omnipotence for achieving the TL-TR. However, a group or collection of TPs may collaborate to satisfy the TL-TR of a task (since group members may have strengths on different trust indicators that any one TP cannot achieve in isolation). As a result, this disclosure identifies a requirement that a TP group may need to be formed so that the TP group members may leverage their respective strengths on different trust indicators in order to collaboratively process TSRs and systematically achieve the TL-TR.

Based on that requirement, a key issue is how a TP group can be formed for TSR processing in order to achieve a TL-TR. There are some existing 5G group formation mechanisms (e.g., Federated Learning member UE selection), but they are not applicable to the TP group formation required by this disclosure. For example, current technology is not targeted for meeting “trust-related” needs. In comparison, the formation of a TP group in this disclosure is to meet specific trust requirements for TSR processing. Most of existing group member selection solutions rely on data collection (using 3GPP event exposure), information consolidation and analytics approaches (via NEF), etc. However, approaches may have a high operation overhead due to data collection and at times data collection may not even be feasible (e.g. certain information cannot be timely collected due to network congestion or certain information cannot be collected due to privacy concern). A different approach for TP group formation (in terms of member selection approach) needs to be designed.

To address the key issue identified above, a trust-aware TP group formation procedure, along with a Group Formation Assistant Function (GFAF) is described. A GFAF may receive a TSR-Profile (TSRP) of a task from a TSR sender. The TSRP may describe a task's TSRs (e.g., TSR schedule/pattern, TSR size/complexity, etc.). The TSRs of a task may be sent from a TSR sender and processed by one or more TPs. A TSRP may also include the diverse trust requirements on TP(s) for TSR processing and an overall TL-TR to be achieved. Given a received TSRP of a task, a GFAF may form a TP group in order to collaboratively process the task's TSRs so that the overall TL-TR can be achieved.

A GFAF may need to support several functionalities, including TP registration, TP group member selection, and TSR sending policy generation.

Regarding TP registration, to perform a TP group formation, a GFAF may need to enable entities (e.g., WTRUs/devices/NFs/ASs) to register as TPs with the GFAF. During TP registration, the potential entities may indicate their willingness to be a TPs as well as their capabilities and capacities to support TSR processing.

Regarding TP group member selection, if a TP group needs to be formed for supporting TSR processing of a specific task, a GFAF may form a TP group for achieving a TL-TR of the task. Proposed herein is a trust declaration/endorsement-based approach for TP member selection. In a trust declaration/endorsement-based approach, TPs may proactively apply for joining a TP group by making trust potential declarations. For example, a declaration may be: “I (e.g., a TP that was registered to the GFAF as a TP) can be a highly-secure TP for processing TSRs of Task-1.” The GFAF may consider the trust potential declarations during TP member selection if the trust declarations can be supported by credible one or more trust endorsements.

The described embodiments may also leverage features of DLT, such as immutability, non-repudiation, and cross-domain interaction for solidifying non-repudiation of trust declarations and trust endorsements. For example, once trust potential declarations are stored in distributed ledgers, they become immutable evidence/commitments, which may stimulate TPs to work diligently when processing TSRs and pay sufficient efforts to meet the trust requirements as they promised in their trust declarations. Distributed ledgers may also be used to store trust endorsements made by reputable stakeholders, which may stimulate a stakeholder to report true endorsements in order to keep their reputations. For example, a trust endorsement may be: “I (i.e., WTRU-1) endorsed that WTRU-2 was a highly-secure TP for processing TSRs in a previous task (e.g. Task-2) that is same or similar to Task-1.” A DLF is presumed to be present in the system, and a GFAF may access distributed ledgers via a DLF, for example, by performing a trust endorsement discovery during TP group member selection or storing trust potential declarations made by TPs.

Regarding TSR sending policy generation, after a GFAF forms a TP group for TSR processing, the GFAF may further create one or more TSR sending policies, which describe how the TSR sender(s) should leverage the formed TP group, e.g. where to send the TSRs for processing. The TSR sending policies will be delivered to the TSR sender(s) for enforcement. The GFAF may conduct task-level optimizations and adjustment when creating TSR sending policies, to ensure the TL-TR can be achieved by the TP group through collaborative TSR processing.

Herein, the roles, such as TP and TSR sender, are logical roles. A given entity/device/WTRU may fulfill one or more logical roles simultaneously. Therefore, although, for illustration purposes, different roles are performed by different entities when implementing the proposed embodiments, all the proposed embodiments can be applied to any scenario where an entity serves in two or more roles. For example, a given entity may act as both a TSR sender for one task and a TP for another task.

The embodiments describes herein can be applied to forming a TP group for any type of task. TSR processing may be triggered when a TP receives a TSR, and the TSR processing may require the TP to perform various operations, including but not limited to computing, communication, sensing, storage, and mixed operations. Furthermore, computing, communication, and sensing are general terms, meaning they could refer to any specific operations required by a vertical application or any current or future 3GPP native functionality. For example, computing may include application-specific processing, such as AR video/image processing or AI/ML-related processing (e.g., Generative AI or GenAI training, processing, or inference based on a Large Language Model). Similarly, communication may refer to 3GPP native communication operations, such as 3GPP ProSe WTRU-to-NW relay operations or any other operations defined in future 3GPP releases or any other non-3GPP communication networks.

In describing the embodiments herein, it may be assumed that the GFAF and the DLF are NFs in the core network. However, all the described embodiments can also be applied to scenarios where the GFAF and the DLF are hosted on entities outside the wireless network, such as a WTRU, a gateway, a base station, or an AF/AS in a data network.

In describing the embodiments herein, it may be assumed that TP group members are WTRUs/devices. However, all the described embodiments may also be applied to cases where TP group members represent logical or physical entities, such as RAN nodes, NFs, or AF/AS.

In describing the embodiments herein, it may be assumed that TP group members are WTRUs/devices interacting using 3GPP ProSe technology. However, all the proposed embodiments can also be applied to scenarios where TP group members interact or communicate using any existing or future communication technology, such as 3GPP 5G Local Area Network (LAN) technology, 5G Virtual Network (VN) groups, shared Wi-Fi hotspots, or shared base stations or any other non-3GPP communication networks.

Herein, the term “distributed ledger” and “DLF” are used as general terms that encompass various existing and future distributed ledger technology solutions. For example, a DLF may manage and interact with a specific underlying distributed ledger system, such as a blockchain-based system, which could provide blockchain-related storage capabilities.

Herein, a distributed ledger may be used as the storage medium for storing trust potential declarations and trust endorsements. However, all the proposed embodiments can also be applied to cases where another storage medium is used, such as centralized storage in UDM/UDR/UDSF managed by a mobile operator, which may enforce strict access control over the storage.

Herein, distributed ledger technology may be used for storing trust potential declarations and trust endorsements. However, the described embodiments may also be applied to cases where a non-distributed-ledger-based approach is used for storing and managing trust potential declarations and trust endorsements. This means that the DLF may be replaced with another alternative function. For example, TSR senders and TPs may sign a legal or notarized agreement with the mobile operator (or another authority) to ensure they make honest declarations or endorsements, which will be stored in the 3GPP system, such as UDM/UDR/UDSF. The agreement may include penalty clauses applicable when TPs provide false declarations. This may also incentivize TPs to diligently process TSRs and make efforts to meet the trust requirements outlined in their trust declarations. Additionally, trust potential declarations and trust endorsements may need to be digitally signed by TSR senders and TPs to ensure non-repudiation.

The embodiments described herein may also be applied to scenarios where the purpose of establishing a TP group is to improve or enhance other metrics besides trust. For example, trust may be defined narrowly as a security-related metric, encompassing aspects such as authentication, authorization, privacy, and confidentiality. Other aspects, such as reliability, performance, agility, accuracy, scalability, resiliency, availability, and consistency, are considered peer metrics of trust. In this context, the proposed embodiments can also be used to form a TP group to improve or enhance these metrics associated with TSR processing. Additionally, the described embodiments may be used to enhance user-related metrics, such as quality of service or quality of experience, which may be influenced by TSR processing (e.g., a TSR processing result returned by a TP may be delivered to the end user for consumption). Moreover, the described embodiments may also be applied to forming a TP group to enhance social metrics related to TSR processing, such as sustainability, inclusiveness, cultural connection, digital connection, diversity, self-sovereignty, adequacy, cleanness, steadiness, accountability, traceability, and efficiency.

Herein, although a 3GPP 5G system is used as a general example of a wireless system, the described embodiments may also be applied to future generations of 3GPP systems (e.g., 6G and beyond) and other types of wireless and fixed access systems (e.g., Wi-Fi). Furthermore, while described embodiments are provided in the context of the 3GPP system, they can also be applied in non-3GPP systems. For example, the proposed GFAF may also be implemented as a function within a distributed ledger system, such as an ETSI PDL-based system.

WTRUs, base stations, and network functions as examples of entities (such as TPs or TSR senders) in a wireless system. However, the described embodiments may be applied to any terminals or other entities (e.g., CPE, NF, AF, AS) such as laptops, Internet-of-Things devices, equipment, future cell phones, drones, roadside units, TV set-top boxes, gateways, access points, satellites, sensor nodes, robots, machines, routers, base stations, radio access network central units, radio access network distribution units, radio access network radio units, and network functions in 5G systems and/or 6G systems.

Although the described embodiments are provided for trust-aware TP group formation, it does not exclude the possibility that the TP group may contain a single member, meaning that a single TP identified by the proposed GFAF could serve all TSRs for a task while achieving TL-TR.

Although the described embodiments are provided for trust-aware TP group formation that assume a TP is a single WTRU/device/entity, the embodiments do not exclude cases where a TP itself is a pre-existing TP group that has already achieved a TL-TR associated with a Task-1. In this scenario, the existing TP group may be considered a TP and may be identified by the proposed GFAF to form a new TP group with other TPs to serve all TSRs of a different Task-2 while achieving a new TL-TR associated with Task-2. The proposed embodiments of this invention may also be applied to hierarchical TP group formation, where a TP group member itself can be a TP group.

Although the described embodiments are provided for trust-aware TP group formation for task-specific request processing, the embodiments may also be applied to other request processing scenarios, such as service request processing. For example, a request could be a service request sent to a TP (acting as a service provider) for service provisioning. The TP may process the service request by performing required service operations (computing, communication, sensing, storage, mixed operations, etc.). The service result will then be returned to the request sender or another beneficiary acting as a service consumer.

Herein, the described embodiments may also be applied to any 3GPP scenario beyond those provided. For instance, the role of the TSR sender may be performed by any WTRU, entity, device, NF in the core network, or AF/AS in a data network. Similarly, the TP role could be assumed by any WTRU, entity, device, NF in the core network, or AF/AS in a data network.

The described embodiments reference existing 3GPP service messages as potential implementations. For example, a given step/request in the proposed procedure may be sent from one NF to another NF using an existing 3GPP Service-Based-Interface (SBI) message, such as Namf_Communication_N1N2MessageTransfer, as defined for AMF. However, the proposed embodiments can also be applied to cases where communication between NFs occurs through new or future messages (SBI-based or non-SBI-based) beyond those currently defined in 3GPP specifications.

For example, if the proposed GFAF is implemented as a new NF, it may be associated with a set of service operations and SBI-based interfaces (i.e., other NFs may communicate with GFAF using various Ngfaf-like messages, which may be specified in a future 3GPP release, similar to the existing service operations defined for other NFs such as AMF and SMF). As an example, certain wireless standards have defined a set of Namf-like messages for AMF, such as the Namf_Communication_N1N2MessageTransfer service operation, which allows an NF to request AMF to transfer a downlink N1 and/or N2 message to a WTRU and/or a RAN node through the AMF. Therefore, the described embodiments may also be applicable to any case where a given step or request in the proposed procedures requires the use of appropriate Ngfaf-like messages when sending a request message to GFAF.

The described embodiments herein describe trust-aware TP group formation for a single task, where two or more TPs collaborate to form a TP group that processes TSRs while meeting the task's TL-TR requirements. However, the described embodiments can also apply to scenarios that require task aggregation, such as when a complex task consists of multiple single tasks.

For example, a complex task related to AI-based data analysis and predication, may include two single tasks (Task-1 and Task-2). Task-1 may be a data pre-processing task while Task-2 may be an AI-based analysis and predication task. TP group-1 may be formed to support the data pre-processing task (in order to achieve a TL-TR-1 associated with Task-1) while TP group-2 may be formed to support the AI-based analysis and predication (in order to achieve another TL-TR-2 associated with Task-2). A TSR sender may first generate TSRs of Task-1, which may include raw data and may be sent to TP group-1 for pre-processing. After the pre-processed data is returned to the TSR sender, the TSR sender may further generate TSRs of Task-2 (including the pre-processed data produced by TP group-1), which may be sent to TP group-2 for AI-based analysis and predication.

A complex task (including Task-1 and Task-2) may also be associated with a Complex-Task-Level Trust Requirement and the described embodiments may also be applicable to assist in forming multiple TP groups (e.g. each of them may be used to process TSRs of a single task) for the complex task in order to meet the Complex-Task-Level Trust Requirement associated with the complex task.

Described herein is an embodiment for TP registration to a GFAF, wherein it the GFAF is a new NF in a wireless network (e.g., the core network and/or an edge network) and the entity to be registered as a TP with the GFAF is a 3GPP WTRU. The described embodiment may be implemented in 3GPP system as an extension of the existing 3GPP WTRU registration procedure.

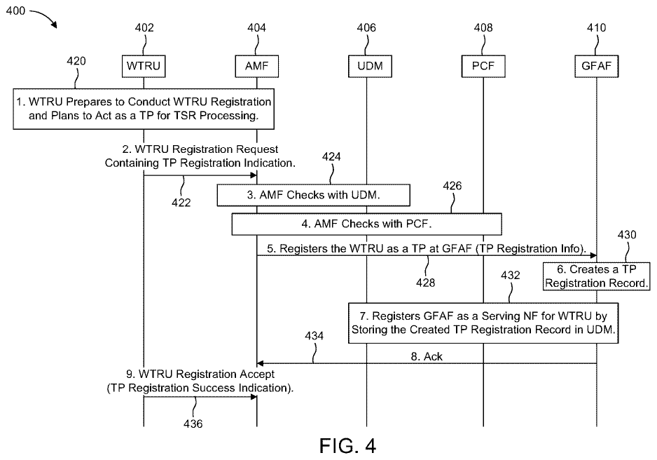

FIG. 4 illustrates an exemplary procedure 400 for TP registration based on 3GPP WTRU registration procedures. At 420, a WTRU 402, acting as a TP, may prepare to conduct a registration procedure with the network and prepare to act as a TP for TSR processing. At 422, WTRU 402 may send a registration request in NAS message to AMF 404 for WTRU registration. The registration request message may include a TP registration indication. WTRU 402 may indicate that it intends to act as a TP so that it can either perform TSR processing by itself or participate in a TP group for collaborative TSR processing of an appropriate task. The registration request may be an existing 3GPP WTRU registration request with additional parameters. For example, one or more of the following parameters may be included in the WTRU registration request sent to AMF 404:

One such parameter may be a TP registration indication, which indicates that the registering WTRU intends to act as a TP for TSR processing. Another parameter may include TP capabilities and corresponding capacities for TSR processing, allowing WTRU 402 to specify the types of operations it can perform. For instance, the WTRU 402 may indicate its capabilities and capacities in computing, communication, sensing, or mixed operations.

Additionally, the WTRU registration request may include a list of supported tasks, which indicates the specific tasks for which the TP can receive and process TSRs. For example, if this parameter includes ‘Task-1,’ it may indicate that the WTRU is capable of receiving and processing TSRs related to Task-1. If this parameter is absent, it may imply that the WTRU can process TSRs for any task, provided that the required processing or operations fall within the capabilities specified in the “TP capabilities and corresponding capacities for TSR processing” parameter.

The WTRU 402 can specify its preferred GFAFs, providing a list of GFAFs it wishes to register with based on factors such as policy or pre-configuration. For example, if WTRU 402 is in Area-1, it may prioritize registering with a GFAF within the same area.

The request may also include additional information to further describe the availability and operational conditions of WTRU 402. This additional information may include, but is not limited to, the task or work schedule (indicating availability as a TP), indoor location, TP service or working area, mobility pattern, data access, and other relevant attributes of the WTRU 402.

At step 424, while processing the WTRU registration request, AMF 404 may also send a request to UDM 406 using the existing Nudm_SDM_Get message with new parameters. This request retrieves necessary information from UDM 406 or other network functions (such as a UDR or a UDSF) related to TP registration. The following parameters may be included in the Nudm_SDM_Get message:

One parameter included in the Nudm_SDM_Get message may be a TP registration indication, which may be used to indicate that the registering WTRU 402 intends to act as TP for TSR processing. Another parameter may be a list of supported tasks, which may be used indicate that the TP intends to receive and process the TSRs of which specific tasks. Other information may also be included to indicate: task or work schedule (e.g., when the WTRU 402 is available as a TP), WTRU indoor location, TP service or working area, mobility pattern, access to data, etc. AMF 404 may check with UDM 406 about the subscription or application data of WTRU 402 in order to decide whether WTRU 402 is eligible to act as a TP.

At 426, while processing the WTRU registration request, AMF 404 may send a request to PCF 408 to obtain policies applicable to TP registration using the existing Npcf_AMPolicyControl_Create interface or other interfaces. For example, if the WTRU 402 indicates that it intends to act as a TP when residing Area-1 but PCF 408 indicates to AMF 404 that an applicable policy specifies that WTRU 402 cannot be a TP when in Area-1, then the TP registration may not approve by AMF 404.

At 428, AMF 404 may send a request to GFAF 410 (e.g., a new Ngfaf type of message in case GFAF is a new NF) to officially register the WTRU 402 as a TP. The request may include the same set of parameters as included at 422.

At 430, GFAF 410 may create a TP registration record for the WTRU 402, which may include the information received at 428. Next, the WTRU 402 may act as a potential TP and may be managed by GFAF 410. For example, GFAF 410 may leverage the WTRU 402 to assist in processing TSRs of a task if the TP capabilities of the WTRU 402 fit one or more task's TSR processing needs.

At 432, GFAF 410 may also store the TP registration records in other places, such as in a UDM, a UDR, and/or a UDSF. For example, GFAF 410 may send the TP registration records to UDM 406 using a Nudm_WTRUCM_Registration message in order to indicate that GFAF 410 is the serving NF for managing the WTRU 402 as a TP.

At 434, GFAF 410 may send an acknowledgement to AMF 404 by indicating that the TP registration record has been accepted, and the WTRU 402 may act as a TP and will be managed by the GFAF 410.

At step 436, AMF 404 may send a WTRU registration acceptance response to WTRU 402. This response may include a parameter indicating that WTRU 402 can act as a TP and will be managed by GFAF 410.

One embodiment may include a process for trust-aware TP group formation where the TSR sender is a WTRU, device, and/or, any similar entity. The GFAF may be a NF in a wireless network (e.g., the core network or an edge network) for helping TP group formation. The DLF may be a NF in a wireless network (e.g., the core network or an edge network) to handle all the accessing to distributed ledgers. The embodiment described herein may be implemented in 3GPP system as an extension of existing 3GPP service request procedures.

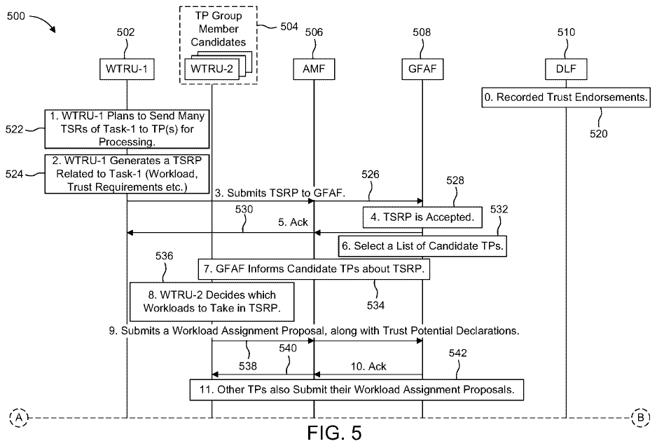

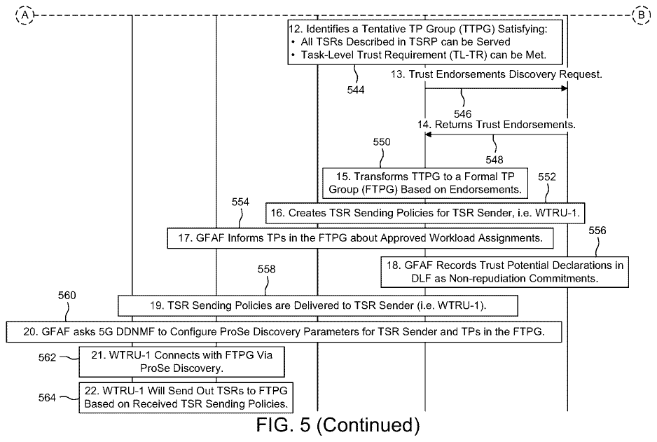

FIG. 5 illustrates an exemplary procedure 500 for trust-aware TP group formation (based on 3GPP service request procedure) where the TSR sender is a WTRU. As provided for in FIG. 5, one or more WTRUs may act as TPs and each TP may have various capabilities for performing task-specific operations (such as computing, communication, sensing, or mixed, etc.). For example, one or more of the TPs may have previously registered with the GFAF as a TP (e.g. during 3GPP WTRU registration, as shown in FIG. 4). It may be assumed that there are trust endorsements recorded in distributed ledgers (as described below), which can be accessed via DLF. The trust endorsements may assist the GFAF for selecting desired TPs during TP group formation.

In FIG. 5, WTRU-1 502 is the TSR sender and WTRU-2 504 is candidate TP and may be part of a TP group that includes one or more additional TP candidates. The TP group may be referred to a “TP Group Member Candidates.”

At 520, DLF 510 may record trust endorsements.

At 522, WTRU-1 502 (acting as a TSR sender) may prepare to send multiple TSRs for Task-1 to one or more TPs for processing. This action may be based on application needs or triggered by an application on WTRU-1 502.

At 524, WTRU-1 502 may generate a TSRP, which is related to Task-1. A TSRP describes a task's TSRs (e.g., schedule/pattern, TSR workload, TSR size, etc.) and the related trust requirements for TSR processing. Different TSRs may be associated with different trust requirements. For example, some TSRs may need to be processed in a highly secure manner while other TSRs may require to be processed in a highly scalable manner. However, the overall success and quality of task may not depend on whether the processing of a single TSR can meet its trust need, but instead, the overall success may depend on whether the TL-TR can be met, which are the aggregated trust requirements “across all the TSRs” associated with the same task.

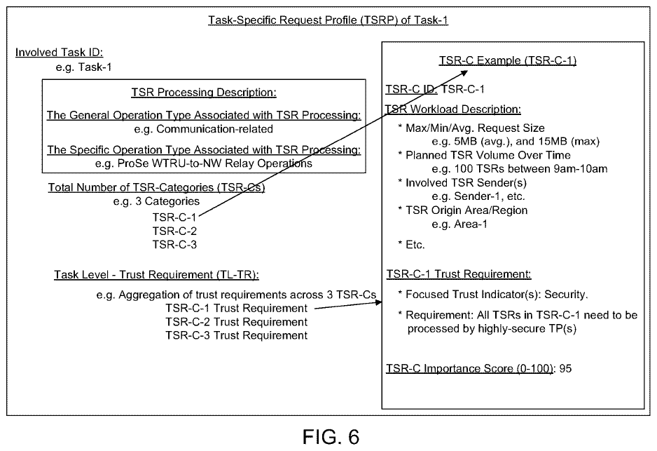

FIG. 6 illustrates an exemplary TSRP of Task-1. The proposed TSRP in FIG. 6 may be extended to include other information which may not be listed below. Conversely, the TSRP may also be simplified to any basic form if needed. As shown in FIG. 6, the TSRP may include the identifier of the involved Task ID to indicate the identifier of the associated task (e.g. Task-1).

The description of TSR processing parameter may include an address, such as a URL or a storage location in UDM/UDR/UDSF, allowing the GFAF to retrieve the description of Task-1. Alternatively, WTRU-2 may directly list essential task information instead of providing an address.

The WTRU-2 504 may include the general operation type associated with TSR processing. This parameter specifies the types of operations a TP must perform to process TSRs for the task, such as computing-related, communication-related, sensing-related, or mixed operations. Additionally, the WTRU-2 504 may define the specific operation type associated with TSR processing, offering a more detailed breakdown of the required TP operations. For example, if TSR processing for Task-1 involves communication-related operations, WTRU-2 504 may specify a 3GPP ProSe WTRU-to-NW relay operation, designating the TP as a WTRU-to-NW Relay WTRU. The WTRU-2 504 may also provide other useful information regarding TSR processing, including hardware and software requirements such as computing software, communication interfaces, or sensing interfaces. Furthermore, WTRU-2 504 may outline the message formats and parameter sets for TSRs, along with the expected responses, ensuring that the TP returns processing results to the TSR sender in a specified format.

The TSRP of Task-1 may also include the total number of TSR-categories (TSR-Cs). This parameter may indicate the total number of TSR-Cs defined for Task-1. In one example, all TSRs of a task may fall under a single TSR-C. TSR categories may follow any criteria, such as processing priority, processing complexity, and/or trust requirements. For example, some high-priority TSRs of a task may belong to one TSR-C, while low-priority TSRs of the same task may belong to a different TSR-C. In another example, TSRs that require processing by high-security TPs may form one TSR-C, while TSRs that require processing by high-scalability TPs may form another TSR-C. Similarly, TSRs sent from TSR sender-1 may belong to one TSR-C, while TSRs from TSR sender-2 may belong to another. In some embodiments, all TSRs of Task-1 are categorized into three TSR-Cs: TSR-C-1, TSR-C-2, and TSR-C-3.

The TSRP of Task-1 may also include a detailed description of each TSR-C. The detailed description parameter may describe the details regarding each TSR-C of a task. The detailed description of each TSR-C may include the TSR-C identifier, which specifies the unique identifier of the TSR-C, such as TSR-C-1. This identifier distinguishes different TSR-Cs within a task and helps categorize TSRs based on defined criteria.

The detailed description of each TSR-C may include the TSR workload description, which outlines the planned TSR workload, schedule, and/or pattern for the TSR-C. The detailed description may include the maximum, minimum, and/or average TSR size, which estimates the expected size of TSRs within the TSR-C and implies their processing complexity. For example, TSRs belonging to TSR-C-1 may typically be 5 MB in size on average, with a maximum size of 15 MB. Additionally, the workload description may include the planned TSR volume over time, indicating the expected number of TSRs within a given time frame. For example, between 9 AM and 10 AM, the system may process a total of 100 TSR-C-1 TSRs.

The detailed description of each TSR-C may include the involved TSR sender(s), which identifies the entities responsible for sending TSRs belonging to the TSR-C. For example, if 100 TSR-C-1 TSRs are scheduled to be sent, TSR sender-1 may send half of them, while TSR sender-2 may send the other half. The system may support multiple TSR senders, and the proposed embodiments in this invention apply to such cases. In a multi-TSR-sender scenario, a leader WTRU (e.g., WTRU-1) may coordinate with other TSR senders to create a common TSRP that aggregates TSR characteristics and trust requirements from all senders. It may be assumed that all 100 TSR-C-1 TSRs will be sent by a single TSR sender, TSR sender-1.

The detailed description of each TSR-C may include the TSR origin area/region, which specifies the geographical location of the TSR sender(s). This information is valuable when determining the most suitable TP(s) for receiving, processing, and serving TSRs. For example, if TSR sender-1 is in Area-1, it may prefer its TSRs to be processed by nearby TP(s).

The detailed description of each TSR-C may include the TSR-C Trust Requirement, which defines the trust-related expectations for TP(s) that process TSRs within the TSR-C. Different TSR-Cs may impose varying trust needs or requirements on TP(s), depending on the task. This parameter specifies the desired trust requirements for one or more TPs that are considered suitable for handling TSRs in the current TSR-C. The proposed embodiments allow for flexible trust requirement definitions in any appropriate format.

A TSR-C trust requirement for a TP in TSR processing may include specific information to define the trust expectations. This requirement consists of a list of focused trust indicators, which specify the trust aspects involved, and a description of the TSR-C trust requirement, which outlines the expected performance for each trust indicator during TSR processing. Each trust indicator may have a set of evaluation criteria, with corresponding requirements based on those criteria.

A trust requirement for TSR-C-1 may focus on security. The evaluation criteria may define a TP's security level based on the security mechanisms it has implemented. For example, if a TP has installed all the latest security software updates, it may be classified as a highly secure TP. Based on this evaluation, the requirement states that only highly secure TPs should process TSRs belonging to TSR-C-1.

A trust requirement for TSR-C-1 may focus on both security and accuracy. In this case, the TSRs belonging to TSR-C-1 must be processed by TPs that are highly secure and capable of producing highly accurate TSR processing results.

A trust requirement for TSR-C-1 may focus on availability. For example, the planned TSR volume for TSR-C-1 may be 500, spanning a long time period from daytime (2-5 PM) to nighttime (5-8 PM). In this scenario, the TSR sender may expect high availability of TPs to process TSR-C-1 TSRs, ensuring that at least one TP remains available for TSR processing at all times. If no single TP can meet this requirement (e.g., no TP remains online continuously from 2 PM to 8 PM), multiple TPs may collaborate to fulfill the requirement. One possible collaboration model involves one TP handling requests from 2 PM to 5 PM and another TP taking over from 5 PM to 8 PM. Accordingly, the trust requirement is met through the coordinated effort of multiple TPs.

A trust requirement for TSR-C-1 may focus on reliability. The TSR sender may expect high reliability, meaning that if a TP stops processing TSRs due to failure, another TP must immediately take over without delay. To meet this requirement, multiple TPs may need to collaborate. For example, a backup TP may always be on standby to seamlessly take over the workload in case of failure, ensuring uninterrupted TSR processing.

The detailed description of each TSR-C may include TSR-importance, which may indicate the priority level of a TSR-C. When categorizing all TSRs of a task into multiple TSR-Cs, each TSR-C may receive a different importance score, such as a value ranging from 0 to 100. TPs may prioritize TSR processing based on these scores. Specifically, TPs may treat trust requirements associated with a high-importance TSR-C with higher priority compared to those linked to a less important TSR-C.

The TSRP of Task-1 may also include a description of the Task-Level Trust Requirement (TL-TR). From a task-wide perspective, the TL-TR may aggregate all TSR-C trust requirements across different TSR-Cs. The TL-TR represents the combined trust requirements for all TSR-Cs within a task. The overall success or quality of a task depends on meeting its TL-TR, rather than fulfilling the requirements of any single TSR. This parameter also defines the conditions under which the TL-TR is considered “met.” The TL-TR may be formulated using any method that aggregates TSR-C trust requirements, including but not limited to the following approaches:

In one scenario, all TSR-Cs may carry equal importance. Under this condition, the system may consider the TL-TR met only when all trust requirements for every TSR-C are fully satisfied. In another, more complex scenario, different TSR-Cs may have varying levels of importance. In this case, a more sophisticated approach may define the TL-TR. For example, the system may consider the TL-TR met only when the trust requirements of medium-and high-importance TSR-Cs are fully satisfied, while low-importance TSR-Cs only require partial fulfillment. Any customized definition of “partially met” may be adopted based on system requirements.

Referring back to FIG. 5, at 526, WTRU-1 502 may send a NAS message to the AMF 506. If the GFAF 508 is implemented as a new NF, it may include a set of service operations and SBI-based interfaces. Other NFs may communicate with GFAF 508 using Ngfaf-like messages, which wireless standards may define similarly to existing service operations for other NFs. For example, 3 GPP 23.502 specifies a set of Namf-like messages for the AMF. One such example is the Namf_Communication_N1N2MessageTransfer service operation, which allows an NF to request the AMF to transfer a downlink N1 and/or N2 message to a WTRU or a RAN node through the AMF. The WTRU-1 502 may send a NAS message to the AMF 506 with the following parameters: (1) the type of request (which indicates that this request is to be sent to GFAF 508) and (2) the TSRP of the task (e.g. Task-1) (which may be included in a N1 container).

Then, AMF 506 may use an applicable service operation (such as a particular Ngfaf-like message (e.g., Ngfaf_TPGroupFormationAssistance_subscribe or Ngfaf_TPGroupFormationAssistance_create if those service operations have already been defined) to forward the TSRP of Task-1 (contained in the N1 container) to GFAF 508. As an alternative, in a system that supports direct communication with the GFAF 508, WTRU-1 502 may send a message with the TSRP directly to the GFAF 508 without forwarding by the AMF 506. For example, in systems that support direct WTRU Service-Based Interfaces (SBIs) with NFs, WTRU-1 502 may send a Ngfaf-like message with TSRP directly to the GFAF 508. Similarly, when the TSP sender is a NF or AF, it may communicate directly with GFAF 508 using Ngfaf-like message.

At 528, after the GFAF 508 receives the TSRP, it may check whether WTRU-1 502 is authorized to initiate TSRs of Task-1. GFAF 508 may also verify the contents of the TSRP using policy or internal configuration. For example, the TSRP may indicate that WTRU-1 502 plans to send out a huge number of TSRs, which may significantly congest the network. If that is the case, GFAF 508 may reject the TSRP and request WTRU-1 502 for re-adjustment (e.g., a reject response may be sent back to WTRU-1 502 at 530, all other later steps are not needed).

At 530, after verification of the TSRP, GFAF 508 may send a response message to AMF 506 corresponding to the Ngfaf-like message received at 526, in which a container may include an acknowledgement to WTRU-1 502 by indicating that the TSRP of Task-1 is accepted and registered at GFAF 508 and the identifier of TSRP of Task-1 (i.e. TSRP-1 originally created by the TSR sender). The AMF 506 may further send a NAS message (as the responses to the NAS message sent from WTRU-1 502 at 526) and the NAS message may include the acknowledgement to WTRU-1 502. If verification fails at 528, GFAF 508 may send a TSRP rejection to WTRU-1 502 and the procedure ends. In addition, it is possible that GFAF 508 may not be able to immediately find a TP group for serving the TSR processing associated with the received TSRP (e.g. when no sufficient desired TPs can be identified by GFAF 508). If that is the case, TP group member identification and TP group formation may take some time and GFAF 508 may indicate to the TSR sender that if a TP group cannot be formed within a certain time limit, the GFAF may give up the effort for forming a TP group.

At 532, the GFAF 508 (or other NFs such as UDM, UDR, or UDSF) may select one or more candidate TPs (e.g., WTRU-2 504) to process TSRs for Task-1, based on TP registration records stored in the system. These candidate TPs should have the necessary capabilities and capacities to handle TSR processing for Task-1 effectively.

At 534, after identifying a list of candidate TPs, GFAF 508 may send a notification to each selected TP, such as WTRU-2 504, to solicit participation in TSR processing for Task-1. This notification may include an indication that GFAF 508 is inviting the TP to process TSRs, the identifier of the involved task (e.g., Task-1), and the TSRP of Task-1.

If some information in the TSRP is sensitive and should not be disclosed to candidate TPs, GFAF 508 may send a tailored version of the TSRP that excludes any confidential details. To deliver these notifications, GFAF 508 may use existing communication mechanisms. For example, GFAF may send a Namf_Communication_N1N2MessageTransfer message to AMF 506, which then relays an N2 message to a RAN node. The RAN node may then broadcast the TSRP of Task-1 to all candidate TPs. In another approach, GFAF may send a Namf_Communication_N1N2MessageTransfer message to AMF 506, which then delivers a NAS message directly to each candidate TP. If a direct service-based interface (SBI) is enabled between GFAF and candidate TPs, GFAF 508 may send the notification using direct SBI messages.

At 536, each candidate TP, such as WTRU-2 504, may receive the TSRP of Task-1 at 534. At this stage, each candidate TP may examine the TSRP contents to determine whether it has the capabilities and capacity to process the TSRs described. Continuing with the same example from FIG. 6, WTRU-2 504 may find that 100 TSR-C-1 TSRs need processing between 9 AM and 10 AM, and the trust requirement of TSR-C-1 specifies that these TSRs should be handled by highly secure TPs. Since WTRU-2 504 ranks itself as a highly secure TP according to the security-level evaluation criteria described in the TSRP of Task-1, it may determine that it still has sufficient capacity to process at least 35 TSR-C-1 TSRs within that time window.

After assessing its capacity, WTRU-2 504 creates a TSR-Processing Workload Proposal (TSR-PWP), which outlines the TSR processing workload that WTRU-2 504, acting as a TP, is willing to undertake. A TSR-PWP may include one or more workload elements, with each element representing a specific workload assigned to WTRU-2 504. For example, in workload element-1, which pertains to TSR-C-1, WTRU-2 504 may specify several key details.

The involved TSR-C indicates which TSR-C the workload element applies to, such as TSR-C-1 of Task-1. The number of TSRs that WTRU-2 504 may process defines how many TSRs from TSR-C-1 WTRU-2 504 is capable of handling, for instance, 35 TSRs in total. This number represents the TSR processing budget that WTRU-2 504 allocates to TSR-C-1. The time period for TSR processing specifies when the TSRs should be sent to WTRU-2 504 for processing, such as 9 AM to 9:30 AM, if WTRU-2 504 expects to be offline from 9:30 AM to 10 AM.

WTRU-2 504 may also provide a trust potential declaration to GFAF 508 to justify its suitability for meeting the trust requirements associated with TSR-C-1. In this case, since the trust requirement mandates processing by a highly secure TP, WTRU-2 504 may submit a declaration regarding its security level. An example of such a declaration is: “I (i.e., WTRU-2 504) can be a highly secure TP (e.g., security score>90) for processing TSR-C-1 TSRs of Task-1.”

Alternatively, WTRU-2 504 may have already pre-stored its trust potential declarations with GFAF 508 during the TP registration process and may periodically update these declarations as necessary, such as when its security level changes over time. In such cases, instead of submitting a new declaration, WTRU-2 504 may simply reference a list of trust potential declaration identifiers stored at GFAF 508.

If WTRU-2 504 intends to undertake additional TSR processing workloads, such as processing TSRs from a different TSR-C-2, it may create another workload element-2, structured similarly to workload element-1, and include it in the same TSR-PWP submission to GFAF 508.

At 538, WTRU-2 504 may send a NAS message to AMF 506, indicating that the request should be forwarded to GFAF 508 and that the TSR-PWP created by WTRU-2 504 may be included in an N1 container. The AMF 506 may then use an applicable service operation, such as a Ngfaf-like message (e.g., Ngfaf_TPGroupFormationAssistance_Update, if defined), to forward the TSR-PWP contained in the N1 container to GFAF 508.

Alternatively, if the system supports direct communication between WTRU-2 504 and GFAF 508, WTRU-2 504 may send a message containing its TSR-PWP related to Task-1 directly to GFAF 508 without AMF 506 forwarding. For example, in systems that enable direct WTRU Service-Based Interfaces (SBIs) with NFs, WTRU-2 504 may transmit a Ngfaf-like message directly to GFAF 508 with its TSR-PWP for Task-1. Similarly, if the TSR sender is a NF or AF, it may communicate directly with GFAF 508 using a Ngfaf-like message. If WTRU-2 504 decides not to participate, it sends a NAS message to AMF 506, indicating that it does not wish to contribute its capabilities or capacity for TSR processing in Task-1.

At 540, GFAF 508 may evaluate the TSR-PWP to determine its validity. For instance, GFAF 508 may check whether the TP possesses the necessary capabilities to process the TSR workload described in the TSR-PWP. If WTRU-2 504 only provided a list of trust potential declaration identifiers at 536, GFAF 508 may verify whether the referenced declarations are retrievable. After validating the TSR-PWP, GFAF 508 may send a response message to AMF 506, corresponding to the Ngfaf-like message received at 538. This response message may include a container acknowledging that GFAF 508 has received the TSR-PWP of Task-1 and will proceed with its evaluation. AMF 506 may then forward this acknowledgment to WTRU-2 504 via a NAS message, serving as a response to the NAS message sent by WTRU-2 504 at 538.

At 542, other candidate TPs may also submit their TSR-PWPs related to Task-1 by following the same procedures outlined at 538 and 540.

At 544, GFAF 508 may evaluate all the TSR-PWPs received from various candidate TPs until it can identify a TTPG that satisfies the necessary conditions. a first condition may require that at least one candidate TP in the TTPG be capable of serving each TSR of Task-1, as described in the TSRP of Task-1. GFAF 508 may explore different collaboration models for TSR processing among candidate TPs. For example, assume that WTRU-2 504 and WTRU-3, both part of the tentative TP group (TTPG), have declared themselves as highly secure TPs. WTRU-2 504 may have committed to processing 35 TSRs, while WTRU-3 may have committed to processing 85 TSRs, both belonging to TSR-C-1. If the TSRP of Task-1 specifies that 100 TSR-C-1 TSRs require processing, the combined workload capacity of WTRU-2 504 and WTRU-3 (35+85=120) ensures that the 100 TSRs can be successfully processed.

A second condition may require that the TTPG collectively meets the TL-TR specified in the TSRP of Task-1 through collaborative TSR processing. The TSRP may define the criteria under which the TL-TR is considered ‘met’, as outlined in the ‘Description of TL-TR’ parameter above. GFAF 508 may ensure that the selected TTPG satisfies these criteria before proceeding to the next step.

At 546, GFAF 508 may send a trust endorsement discovery request to a distributed ledger function (DLF) 510. It may assume that the DLF 510 operates as a new NF with a set of service operations and corresponding Ndlf-like messages, such as Ndlf_TrustEndorsement_Query, if such a service operation has already been defined for DLF 510. The AMF 506 may then use an applicable service operation, such as a specific Ndlf-like message (e.g., Ndlf_TrustEndorsement_Query), to send a trust endorsement discovery request to DLF 510. This request may include a discovery filter criteria, and aims to verify whether the trust potential declarations made by candidate TPs in the TTPG can be trusted.

Various stakeholders may create and record trust endorsements in distributed ledgers. A trust endorsement may include multiple pieces of information. A trust endorsement may include a distributed ledger identifier, which may correspond to a transaction ID in a distributed ledger that stores the trust endorsement. A trust endorsement may also include the endorser's identifier, indicating the entity that created the trust endorsement. Different stakeholders may act as trust endorsers. For example, if WTRU-5, acting as a TSR sender, sends TSRs for Task-N to WTRU-2, which acts as a TP, and WTRU-2 meets all or most trust requirements posed by WTRU-5, then WTRU-5 may submit a trust endorsement for WTRU-2. Another example involves a trust management function (TMF), potentially operated by a mobile network provider, which evaluates whether WTRU-2 met the trust requirements defined by WTRU-5. If TMF determines that WTRU-2 has met the necessary trust requirements, it may issue a trust endorsement for WTRU-2. If TMF and DLF function as separate systems, TMF may submit trust endorsements to DLF for storage. Alternatively, if TMF includes an internal DLF sub-function, it may directly manage multiple distributed ledgers and store trust endorsements without involving a separate DLF.

The trust endorsement may also include the identifier of the involved TP, specifying which TP the endorsement references. Continuing with the earlier example, if WTRU-5 (as a TSR sender) sends TSRs for Task-N to WTRU-2 (acting as a TP) and creates trust endorsement-1 for WTRU-2, this parameter would be set to ‘WTRU-2.’ The trust endorsement may also include the identifier of the involved task, which specifies which task the trust endorsement relates to. If WTRU-5 generates a trust endorsement for WTRU-2 regarding Task-N, the identifier will reflect ‘Task-N.’

A trust endorsement may also provide general information about the involved task (e.g., ‘Task-N’), such as the operation type associated with TSR processing, which indicates whether Task-N involves computing-related, communication-related, sensing-related, or mixed operations. The general information may also specify the specific operation type of TSR processing, such as 3GPP ProSe WTRU-to-NW relay operations for Task-N if the task requires communication-related operations. Additionally, the trust endorsement may include other useful information regarding TSR processing for Task-N, such as required software/hardware, adopted message formats, and parameter sets.

A trust endorsement may also provide the content of the endorsement consists of one or more endorsement elements, which express evaluations about the TP (e.g., WTRU-2) by the endorser. For instance, an endorsement element may state that WTRU-5 (as a TSR sender) confirms that WTRU-2 is a highly secure TP for processing TSRs of Task-N. Another example may be that TMF endorses WTRU-2 for having a high availability score in processing TSRs for Task-N. Additionally, each endorsement element may include constraints, such as validity periods or geographical limitations. For example, WTRU-5 may specify that its endorsement of WTRU-2 remains valid only for a limited time or applies only when WTRU-2 operates in a specific area.

Alternative forms of trust endorsements are also possible, such as ranking systems or positive feedback related to a previous trust declaration made by a TP. For example, a TSR sender may create a trust endorsement stating that it trusts a prior declaration made by WTRU-2, in which WTRU-2 claimed to be a highly secure TP for processing TSRs of Task-N. The trust endorsement may also include the endorser's digital signature, which uses the endorser's private key to ensure authenticity.

The trust endorsement may further include additional information about the endorser, such as its contact details or reputation score. Trust endorsements from highly reputable entities, such as a government organization or a mobile operator-owned TMF, may carry more credibility than endorsements issued by an individual entity or a WTRU with an unknown or low reputation score.

When GFAF 508 sends a trust endorsement discovery request to DLF 510, it may include a discovery filter to refine the search criteria. The discovery filter may specify one or more filtering conditions to locate relevant trust endorsements related to WTRU-2 504. One criterion may include a list of identifiers for candidate TPs in the TTPG, ensuring that GFAF retrieves trust endorsements specific to WTRU-2 504.

The filter may also define desired task characteristics, such as the general operation type associated with TSR processing. For example, the desired task characteristics may be a general operation type associated with TSR processing to specify that the GFAF 508 is only interested in trust endorsements related to a specific general operation type. For example, because WTRU-2 504 has been identified as a candidate TP for processing TSRs of Task-1, and Task-1 involves communication-related operations, the parameter may include the value ‘communication-related.’ This ensures that GFAF 508 retrieves only trust endorsements evaluating the performance of WTRU-2 504 in communication-related tasks, making them relevant as a reference at this time.

The filter may also define desired task characteristics, such as the specific operation type associated with TSR processing to indicate that GFAF 508 is only interested in trust endorsement(s) related to specific operation types. For example, because WTRU-2 was identified as a candidate TP for processing TSRs of Task-1 and the specific operation type of Task-1 is 3GPP ProSe WTRU-to-NW relay operation, the parameter value ‘3GPP ProSe WTRU-to-NW relay operation’ may be included in this parameter since only the trust endorsements on WTRU-2 about its trust performance for conducting 3GPP ProSe WTRU-to-NW relay operations (in one or more historical tasks) are valuable as a reference for GFAF 508 at this time.

The filtering criteria may also include a list of focused trust indicators. GFAF 508 may be only interested in trust endorsement(s) related to one or more specific trust indicators, which are included in this parameter. For example, since WTRU-2 was identified as a candidate TP for processing TSRs of Task-1 and WTRU-2 has made several trust declaration(s) on security, “security” is a focused trust indicator and may be included in this parameter.

The filtering criteria may also include credibility criteria of desired endorsers to indicate that the GFAF 508 is only interested in trust endorsement(s) that are made by desired endorsers who pass the credibility criteria as described in this parameter. This is to make sure the trust endorsements to be leveraged by GFAF 508 can be credible. For example, this parameter may include a list of credible endorser identifiers. Another example, this parameter may indicate that only endorsers having a high reputation score are desired.

In addition to trust endorsements, which act as positive feedback on a TP's trust performance, GFAF may also attempt to discover negative feedback on TPs'historic TSR processing activities if such records exist in distributed ledgers.

At 548, DLF 510 may send a response message to GFAF 508, corresponding to the Ndlf-like message received at 546. This response may include one or more trust endorsements that were identified based on the discovery filtering criteria specified by GFAF 508 at 546.

At 550, GFAF 508 may re-examines the TTPG generated at 544, along with the TSR-PWPs submitted by candidate TPs, using the trust endorsements received at 548. For example, for a given workload element in the TSR-PWP of a candidate TP (e.g., WTRU-2 504) and its related trust potential declarations, GFAF 508 may approve the workload if the trust potential declarations made by the TP are supported by one or more trust endorsements received at 548. For example, the TSR-PWP of WTRU-2 504 may include a workload element-1, indicating that WTRU-2 504 is willing to process 35 TSR-C-1 TSRs for Task-1, and WTRU-2 declares, “I (i.e., WTRU-2) can be a highly secure TP for processing TSR-C-1 TSRs of Task-1.” GFAF 508 may then find that at least one trust endorsement received at 548 confirms that WTRU-2 504 was a highly secure TP for processing TSRs of Task-2, which is very similar to Task-1 (e.g., both require the same type of task-specific operations). In this case, the trust endorsement for Task-2 may serve as valuable support for the trust potential declaration for Task-1 from WTRU-2 508.

GFAF 508 may approve a set of workload elements from the TSR-PWPs submitted by TPs in the TTPG. GFAF 508 may evaluate whether each TSR specified in the TSRP of Task-1 may be processed by at least one candidate TP using at least one of the approved workload elements. If this condition is met, GFAF transforms the TTPG into a Formal TP Group (FTPG), selecting only TPs whose TSR-PWPs contain at least one approved workload element. Some TPs initially included in the TTPG may not be part of the final FTPG if none of their workload elements are approved by GFAF. This may occur if their trust potential declarations cannot be verified through credible trust endorsements from DLF (or TMF).

Alternatively, 546 and 548 may be conducted before 544, allowing GFAF 508 to consider trust endorsements when selecting desired TPs for directly forming the FTPG. In this case, 544 and 550 may be combined into a single step.

In addition to trust endorsements stored in distributed ledgers, GFAF 508 may also perform further evaluations on candidate TPs in the TTPG to determine whether an FTPG can be formed. For example, if GFAF 508 operates in a system utilizing a Zero-Trust Architecture, it may conduct dynamic trust evaluations based on the latest trust status of TPs in the TTPG before deciding whether to transform the TTPG into an FTPG.

At 552, after forming an FTPG for TSR processing, GFAF 508 may create one or more TSR sending policies that specify how a TSR sender (e.g., WTRU-1 502) can utilize the FTPG, including where to send TSRs for processing. GFAF 508 may then deliver these TSR sending policies to the TSR sender for enforcement. The goal of GFAF 508 is to enable the TP group to process TSRs collaboratively in order to meet the TL-TR defined in the TSRP of Task-1. To optimize performance and ensure compliance with TL-TR, GFAF 508 may conduct task-level optimizations and make adjustments when creating TSR sending policies for the TSR sender.

For example, if, at 550, GFAF 508 approved two workload elements: one from WTRU-2 504 and another from WTRU-3, WTRU-2 504 may be capable of processing 35 TSR-C-1 TSRs for Task-1, while WTRU-3 may handle 85 TSR-C-1 TSRs for Task-1. If the TSRP from WTRU-1 (the TSR sender) specifies that 100 TSR-C-1 TSRs require processing, GFAF 508 may create TSR sending policies that allocate the workload between WTRU-2 504 and WTRU-3, ensuring the FTPG functions efficiently to meet the TL-TR.

One possible TSR sending policy directs WTRU-1 to randomly distribute TSR-C-1 TSRs between WTRU-2 and WTRU-3 for processing. However, WTRU-1 should not send more than 35 TSRs to WTRU-2 504, as this exceeds its approved workload capacity. Another policy might specify a proportional workload distribution, requiring WTRU-1 to send P TSRs to WTRU-2 and Q TSRs to WTRU-3, where P≤35, Q≤85, and P+Q=100. In another scenario, GFAF 508 may define a backup-based TSR sending policy, instructing WTRU-1 502 to send all TSRs to WTRU-2 504, while WTRU-3 serves as a backup TP. If WTRU-2 504 encounters a failure and can no longer process TSRs, it immediately offloads TSR processing to WTRU-3.

Additionally TSR-C-1, GFAF 508 may also create TSR sending policies for other TSR-Cs within Task-1, such as TSR-C-2 and TSR-C-3. From a task-level perspective, every decision made by GFAF 508, whether in FTPG formation in Step 15 or TSR sending policy creation in 552, aims to achieve the TL-TR specified in the TSRP. Furthermore, in systems with multiple TSR senders, GFAF 508 may generate a unique set of TSR sending policies for each TSR sender and deliver them accordingly for enforcement.

At 554, GFAF 508 may inform each TP in the FTPG about its approved workload assignments. For example, if WTRU-2 504 submitted its TSR-PWP for Task-1 at 538, GFAF 508 may have approved only a portion of the workload elements at 550. For each approved workload element, such as workload element-1 listed at 552, GFAF 508 may include additional relevant information and returns it to the corresponding FTPG member, such as WTRU-2 504. This information may include the identifier of the approved workload element, the identifier of the involved task (e.g., Task-1), the identifier of the involved TP (e.g., WTRU-2), and the identifier of the involved TSR-PWP.

Additionally, GFAF 508 may provide instructions on how WTRU-2 504 should prepare to receive and process TSRs related to the approved workload element. The specifics depend on the TSR sending policy enforced by the TSR sender. For instance, if Example TSR Sending Policy-1 from 552 is enforced for WTRU-1 (the TSR sender), GFAF 508 may inform WTRU-2 504 that it can receive up to 35 TSR-C-1 TSRs for Task-1, aligning with its approved workload capacity.

In some cases, GFAF 508 may also provide TP collaboration instructions to enhance trust performance in key areas such as scalability and reliability. For example, if Example TSR Sending Policy-3 from 552 is enforced, WTRU-2 504 may receive more than 35 TSR-C-1 TSRs. However, if WTRU-2 504 cannot process all TSRs in time, GFAF 508 may instruct WTRU-2 504 to forward excess TSRs to WTRU-3 for processing, enabling collaborative processing and improving the group's scalability. Similarly, if WTRU-2 504 encounters a failure and stops processing TSRs, GFAF 508 may direct WTRU-2 504 to notify WTRU-3, which can immediately take over the workload to ensure continuous TSR processing. By collaborating, WTRU-2 504 and WTRU-3 together improve the overall reliability of the FTPG. GFAF 508 may create and assign any TP collaboration instructions to ensure the group meets trust requirements, considering these factors when designing TSR sending policies at 552.

The request sent to each FTPG member may also include the identifier of the TP group to which the TP belongs and the identifiers of other group members in the FTPG.

Similar to 534, GFAF 508 may use existing communication mechanisms to send the approved workload elements to the FTPG members. For example, GFAF 508 may send a Namf_Communication_N1N2MessageTransfer message to AMF 506, which then forwards a NAS message to the FTPG TPs. Alternatively, if a direct SBI is enabled between FTPG TPs and GFAF 508, GFAF 508 may use direct SBI messages to send approved workload elements.

Each TP in the FTPG should confirm its willingness to process TSRs according to the approved workload assignments by sending a confirmation to GFAF 508. If GFAF 508 receives confirmations from all FTPG members, the process proceeds to 556. Otherwise, further negotiations and adjustments may be required. In such cases, GFAF 508 may need to revisit 550 or even restart from 544 to reform the FTPG with new TP selections.

At 556, GFAF 508 may record all trust potential declarations associated with the approved workload assignments in distributed ledgers as non-repudiation commitments via DLF 510, since all TPs in the FTPG confirmed their participation at 554. GFAF 508 may use an applicable service operation, such as a Ndlf-like message (e.g., Ndlf_TrustRecords_Create, if such a service operation has already been defined for DLF), to send the trust potential declarations to DLF 510 for storage in the distributed ledgers. This process encourages TPs to work diligently while processing TSRs and to put forth sufficient effort to meet the trust requirements they committed to in their trust declarations. If a TP consistently fails to achieve the trust performance it promised in its trust potential declarations, the affected TSR senders may express dissatisfaction and record negative feedback regarding the TP's declarations in the distributed ledgers. Conversely, if a TP successfully fulfills the trust performance it committed to, thereby meeting the trust needs of the corresponding TSR sender, the TSR sender or other stakeholders, such as a TMF conducting trust evaluations, may submit positive feedback (e.g., in the form of trust endorsements) to the distributed ledger.

At 558, GFAF 508 may deliver the TSR sending policies created 552 to the TSR sender (WTRU-1 502). For example, GFAF 508 may send a Namf_Communication_N1N2MessageTransfer message to AMF 506, including the TSR sending policies and other relevant parameters, such as the task identifier, the FTPG identifier, and the TSR sender identifier. AMF 506 may then forward this message, containing the TSR sending policies and other details, to the TSR sender via a NAS message. If a direct service-based interface exists between the TSR sender and GFAF, GFAF may send the TSR sending policies directly via SBI messages. Alternatively, GFAF 508 may deliver this information alongside ProSe discovery parameters to the TSR sender at 560, provided the TSR sender is a WTRU. This may also take place after 560. In another example, GFAF 508 may store the TSR sending policies locally and function as a TSR dispatcher, instructing TSR senders to forward all TSRs to GFAF 508, which then distributes them to the appropriate TPs for processing based on the created TSR sending policies.

At 560, TSR senders and TPs are WTRUs/devices that interact through 3GPP ProSe communications. Therefore, GFAF 508 may first enable mutual discovery between the TSR sender and TPs in the FTPG (or even enable TPs to discover each other if they need to communicate for collaborative TSR processing). To facilitate this, GFAF 508 may request the existing 5G DDNMF to configure ProSe discovery parameters for both the TSR sender and the TPs in the FTPG. For example, the 5G DDNMF may opt for Direct Discovery Model-B to establish discovery between the TSR sender (e.g., WTRU-1 502) and the TPs (e.g., WTRU-2 504) in the group. The ProSe discovery parameters, such as a specific application code used to enable ProSe discovery for an FTPG, may be delivered to the TSR sender and TPs in the FTPG either by 5G DDNMF or directly by GFAF 508. 558 and 560 may be generalized to allow communication between the TSR sender and TPs (or among TPs) in the FTPG to use any existing or future communication technology, in addition to 3GPP ProSe communication. For example, 5G LAN technology or any other non-3GPP technology may support such communication.

At 562, WTRU-1 502 (as the TSR sender) and the TPs (e.g., WTRU-2 504) in the FTPG perform 3GPP ProSe direct discovery based on the instructions provided by 5G DDNMF and establish a direct communication link over PC5. Similar to 560, this may also be generalized, allowing communication between the TSR sender and TPs (or among TPs) in the FTPG to use any existing or future communication technology, beyond 3GPP ProSe communication. For instance, 5G LAN technology may also support this step.

At 564, WTRU-1 504 may initiate TSR transmission and sends TSRs to TPs in the FTPG for processing, following the TSR sending policies received at 558.

The procedure outlined in FIG. 5 may also be implemented using a 3GPP SA6 architecture. In this approach, GFAF 508 operates as a GFAF server, while WTRU-1 502 (as the TSR sender) and TPs (e.g., WTRU-2 504) function as GFAF clients. The DLF 510 may be deployed as a DLF server, and when the GFAF server interacts with the DLF server, it acts as a DLF client.

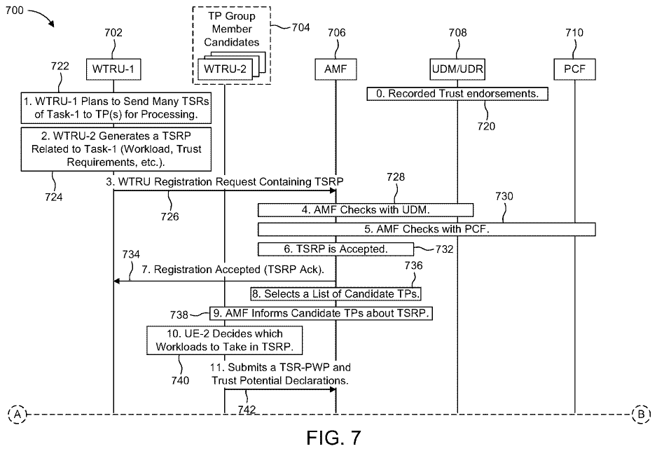

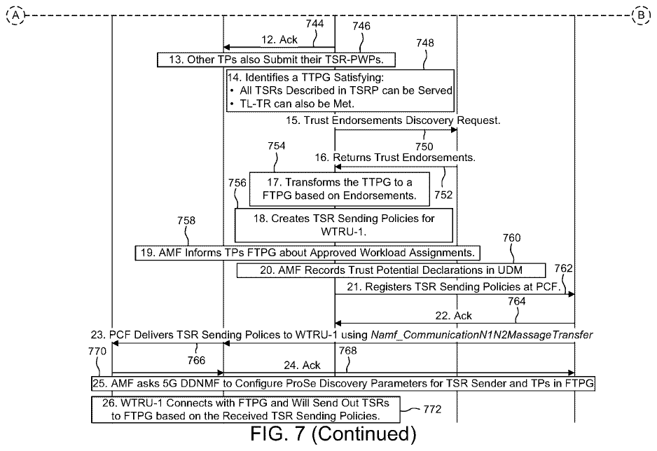

FIG. 7 illustrates an exemplary procedure 700 for trust-aware TP group formation (based on 3GPP service request procedure) where the TSR sender is a WTRU or a device and a GFAF is implemented by an AMF and the functionalities of the DLF are implemented by a UDM or a UDR. As provided in FIG. 7, multiple WTRUs may act as TPs and each of them may have various capabilities for performing task-specific operations (such as computing, communication, sensing, or mixed, etc.). For example, WTRU-2 704 may have already registered to AMF 706 as a TP (e.g. during WTRU registration) using the procedure described above. There are trust endorsements recorded in distributed ledgers, which may be accessed via UDM/UDR 708 or in other NFs such as a UDSF. These trust endorsements may assist AMF 706 for selecting desired TPs during TP group formation.

At 720, UDM/UDR 708 may record trust endorsements.

At 722, based on application needs, WTRU-1 702 (acting as a TSR sender) may prepare to send multiple TSRs for Task-1 to one or more TPs for processing. This step corresponds to 522 in FIG. 5.

At 724, WTRU-1 702 may generate a TSRP related to Task-1. This step corresponds to 524 in FIG. 5.

At 726, WTRU-1 702 may send a 3GPP WTRU registration request to AMF 706, including the TSRP. This step follows the same set of parameters as described in 526 in FIG. 5.

At 728, AMF 706 may send a request to UDM/UDR 708 using the existing Nudm_SDM_Get interface to obtain necessary information from UDM 708 or other NFs such as UDR or UDSF. Upon receiving the TSRP, AMF 706 may conduct processing and validation, ensuring that the TSRP of Task-1 meets required conditions. The message may include new parameters such as the TSR sender indication, identifying the WTRU-1 702 as a TSR sender, and the TSRP generated by the TSR sender, which outlines how WTRU-1 702 intends to generate and transmit TSRs. The TSRP may also contain additional details, including the TSR workload pattern/schedule, the TSR sender's residence location, or travel patterns. AMF may consult UDM/UDR 708 to verify WTRU-1's 702 subscription or application data to determine whether it is eligible to act as a TSR sender or if it is permitted to generate the TSRP at that time.

At 730, AMF 706 may request applicable policies for WTRU-1 702 from PCF 710 using the Npcf_AMPolicyControl_Create interface. This request may include the TSR sender's identifier, context information (such as current location and serving base station), the task identifier associated with the TSRs, and the TSRP submitted in 724. For instance, if the TSRP states that WTRU-1 702 plans to send TSRs while residing in Area-1, but PCF policies prohibit sending TSRs of Task-1 in that location, AMF 706 may reject the TSRP submitted by WTRU-1 702.

At 732, if 728-730 verify the TSRP, AMF 706 may register and store Task-1'S TSRP, potentially saving it in UDR or other NFs. AMF 706 may also generate a globally unique identifier for the TSRP of Task-1, such as TSRP-1. This step corresponds to 528 in FIG. 5.

At 734, AMF 706 may send a WTRU registration accepted response to WTRU-1 702, confirming the TSRP acceptance.

At 736, based on TP registration records stored in AMF 706 (or NFs like UDM/UDR/UDSF), AMF 706 may select one or more candidate TPs (e.g., WTRU-2 704) capable of processing TSRs of Task-1. These candidate TPs should possess the necessary capabilities and capacities to handle TSR processing. This step corresponds to 532 in FIG. 5.

At 738, AMF 706 may notify each candidate TP (e.g., WTRU-2 704) about Task-1's TSRP using existing or new communication solutions. For example, AMF 706 may send an N2 message to a RAN node, which then broadcasts the TSRP of Task-1 to all candidate TPs. Alternatively, AMF may send a NAS message directly to desired candidate TPs. This step corresponds to 534 in FIG. 5, including all the described parameters.

At 740, after receiving the TSRP, each TP (e.g., WTRU-2 704) may decide which workloads it can process. Each candidate TP may then create a TSR-PWP, following the same process as 536 in FIG. 5.

At 742, WTRU-2 704 may submit its TSR-PWP related to Task-1 to AMF 706 via a NAS message. This step corresponds to 538 in FIG. 5.

At 744, AMF 706 acknowledges receipt of WTRU-2's 704 TSR-PWP, confirming that it will undergo evaluation. This step corresponds to 540 in FIG. 5.

At 746, other TPs also submit their TSR-PWPs to AMF 706 following the process in 740-742. This step corresponds to 542 in FIG. 5.

At 748, AMF 706 evaluates all received TSR-PWPs from different candidate TPs, identifying a TTPG that meets two criteria: (1) all TSRs in the TSRP can be served, and (2) the TL-TR specified in the TSRP can potentially be met. This step corresponds to 544 in FIG. 5.

At 750, because DLF operates under UDM, AMF 706 may send a trust endorsement discovery request using Nudm_SDM_Get to UDM (or another NF such as UDR/UDSF) to evaluate whether the trust potential declarations made by candidate TPs in TTPG can be trusted. This step corresponds to 546 in FIG. 5 and includes all corresponding parameters. Alternatively, if DLF is implemented within UDR, AMF 706 may send the trust endorsement discovery request using Nudr_DM_Query to UDR 708.

At 752, UDM/UDR 708 (or other NFs such as UDSF) may identify and return one or more trust endorsements to AMF. This step corresponds to 548 in FIG. 5.

At 754, AMF 706 may re-evaluate the TTPG and its TSR-PWPs to determine which trust declarations are supported by credible trust endorsements from 752. If at least one candidate TP can serve a TSR from the TSRP of Task-1 using an approved workload element, AMF 706 may transform the TTPG into an FTPG. AMF 706 may also apply zero-trust principles to dynamically assess the latest trust status of TPs in the TTPG before finalizing the FTPG. This step corresponds to 550 in FIG. 5.

At 756, after AMF 706 may create an FTPG for TSR processing related to Task-1, it may generate one or more TSR sending policies for the TSR sender (e.g., WTRU-1 702). Since there may be multiple TSR senders in the system, AMF creates TSR sending policies for each TSR sender and delivers them for enforcement. This step corresponds to 552 in FIG. 5.

At 758, AMF 706 may inform each TP in the FTPG about its approved workload assignments. This step corresponds to 554 in FIG. 5 and includes all the described parameters. Similar to 554, AMF 706 may use existing mechanisms to communicate the approved workload elements to FTPG members. For example, AMF 706 may send a NAS message to the TPs in the FTPG, and each TP may respond with a confirmation to AMF 706, verifying its willingness to process TSRs as described in the approved workload assignments.

At 760, for all trust potential declarations associated with the approved workload assignments, AMF may record them in distributed ledgers as non-repudiation commitments in UDR (or other NFs like UDSF). This step corresponds to 556 in FIG. 5. AMF 706 may send a trust potential declaration recording request to UDR using Nudr_DM_Create to ensure proper logging.

At 762, AMF 706 may send a request to PCF using the Npcf_AMPolicyControl_Create message to register the created TSR sending policies at PCF. The request may include new parameters such as the purpose of the request (e.g., registering TSR sending policies for enforcement), identifiers of the TSR sending policies, the involved task (e.g., Task-1), and the TSR sender(s) to whom the policies apply (e.g., WTRU-1 702).

Alternatively, 756 may be performed by PCF 710, meaning PCF 710 may be responsible for creating TSR sending policies instead of AMF 706. AMF 706 may send a request to PCF 710 using Npcf_AMPolicyControl_Create, including detailed FTPG and TL-TR information. PCF 710 may then gather additional data from other NFs (such as UDM/UDR) and generate the TSR sending policies with the objective of achieving TL-TR. PCF would then return the TSR sending policies to AMF 706, which would deliver them to the TSR sender (WTRU-1) for enforcement. If PCF 710 creates the TSR sending policies, 762 and 764 are not needed.

At 764, PCF 710 may accept the TSR sending policies and sends an acknowledgment to AMF 706.

At 766, PCF 710 may transmit the TSR sending policies to AMF 706 using the Namf_CommunicationN1N2MessageTransfer message. The parameters in this request may include a list of TSR sending policies, the task identifier, the FTPG identifier, and the TSR sender identifier. AMF 706 then forwards the message to WTRU-1 702 using a NAS message. Alternatively, 762 and 764 may be skipped, allowing AMF 706 to deliver the TSR sending policies directly to the TSR sender (WTRU-1 702) via a NAS message.

At 768, WTRU-1 702 may acknowledge receipt of the TSR sending policies by sending a NAS message to AMF 706. AMF 706 may then forward an acknowledgment to PCF 710, if applicable.

At 770, AMF 706 may request 5G DDNMF to configure ProSe discovery parameters for the TSR sender and TPs in the FTPG. This step corresponds to 560 in FIG. 5. Similar to 560, 770 may be generalized to support communication technologies beyond 3GPP ProSe, such as 5G LAN technology, for communication between the TSR sender and TPs (or among TPs).

At 772, WTRU-1 702 may establish a connection with the FTPG and begins sending TSRs according to the received TSR sending policies. This step corresponds to 562 and 564 in FIG. 5.

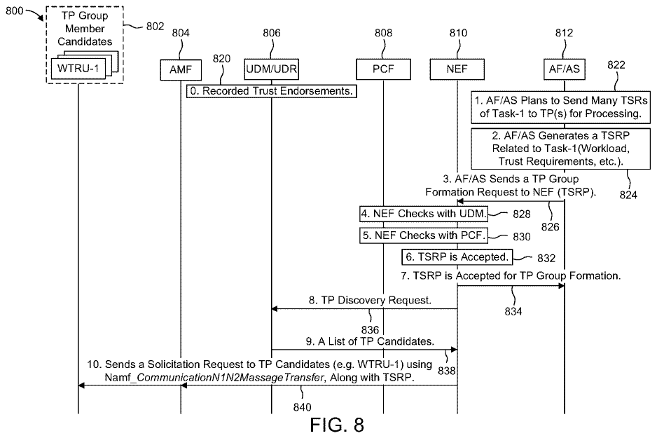

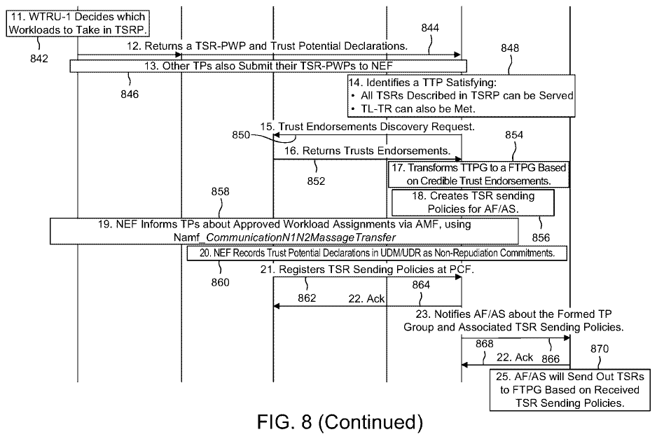

FIG. 8 illustrates an exemplary procedure 800 for trust-aware TP group formation where the TSR sender is an AF/AS. As provided for in FIG. 8, multiple WTRUs may act as TPs and each of them may have various capabilities for performing task-specific operations (such as computing, communication, sensing, or mixed, etc.). Those WTRUs may have already registered to AMF as a TP (e.g. during WTRU registration). After WTRU registration, AMF may store the corresponding TP registration records in UDM/UDR. There are trust endorsements recorded in distributed ledgers, which can be accessed via UDM/UDR.

At 820, UDM/UDR 806 may record trust endorsements.

At 822, based on application needs, AF/AS 812 (acting as a TSR sender) may prepare to send multiple TSRs for Task-1 to TP(s) for processing. This step corresponds to 522 in FIG. 5.

At 824, AF/AS 812 may generate a TSRP related to Task-1. This step corresponds to 524 in FIG. 5. AF/AS 812 may seek to identify multiple TPs for collaboratively processing TSRs of Task-1 to achieve the TL-TR as specified in the TSRP.

At 826, AF/AS 812 may send a TP group formation request to NEF, containing the TSRP. The request may use a new service operation message defined for NEF to assist TP group formation, such as Nnef_TPGroupFormationAssistance_Subscribe. Alternatively, the request may be sent using an extension of an existing NEF service operation, such as Nnef_MemberUESelectionAssistance_Subscribe, which is used for member UE selection in Federated Learning (FL). New parameters in this request may include an indication that the request is related to TP group formation and may include the same set of parameters as included in 526 of FIG. 5.

At 828, NEF 810 may send a request to UDM/UDR 806 using the existing Nudm_SDM_Get message to obtain necessary information from UDM 806 or other NFs like UDSF. Upon receiving the TSRP, NEF 810 may conduct processing and validation, ensuring that the TSRP of Task-1 meets the required conditions. The message may include new parameters such as the TSR sender indication, identifying AF/AS 812 as the TSR sender, and the TSRP generated by the TSR sender, which outlines how AF/AS 812 intends to generate and transmit TSRs. The TSRP may also contain additional details, including the TSR workload pattern/schedule, the TSR sender's deployment location, or travel patterns. NEF 810 may consult UDM/UDR 806 to verify whether AF/AS 812 is eligible to act as a TSR sender or whether it is permitted to generate the TSRP at that time.

At 830, NEF 810 may request applicable policies for AF/AS 812 from PCF 808 using a Npcf-like message, such as a new Npcf_Nnef_TPGroupFormationAssistancePolicy_Create. The request parameters may include the TSR sender's identifier, context information (such as AF/AS deployment location), the task identifier associated with the TSRs, and the TSRP submitted 824.

At 832, if 828 and 830 verify the TSRP, NEF 810 may register and store Task-1'S TSRP. Additionally, NEF 810 may generate a globally unique identifier for the TSRP of Task-1, such as TSRP-1. This step corresponds to 528 in FIG. 5.

At 834, NEF 810 may send a response to AF/AS 812, acknowledging the acceptance of the TSRP and establishing a subscription for TP group formation, provided that AF/AS sent a Nnef_TPGroupFormationAssistance_Subscribe message at 826.

At 836, assuming that other WTRUs have already indicated to AMF 804 that they can act as TPs (e.g., during their WTRU registration), AMF 804 may store TP registration records in UDR 806. Accordingly, NEF 810 may send a TP discovery request to UDR 806 using Nudr_DM_Query to identify potential TPs that can process TSRs of Task-1. The discovery request may include filter criteria specifying desired location, processing capabilities, and workload capacity.

At 838, UDR 806 may return a list of candidate TPs to NEF 810 as the TP discovery result.

At 840, NEF 810 may notify each candidate TP about Task-1'S TSRP using existing or new communication solutions. For example, NEF 810 may send a Namf_Communication_N1N2MessageTransfer message to AMF 804, which will then forward it as an N2 message to a RAN node for broadcast. Alternatively, NEF 810 may send a NAS message to candidate TPs via AMF 804, or use direct SBI messaging if supported. This step corresponds to 534 in FIG. 5.

At 842, after receiving the TSRP, each TP (e.g., WTRU-2) may determine which workloads it can handle. Each candidate TP then creates a TSR-PWP, corresponding to 536 in FIG. 5.

At 844, WTRU-2 may send its TSR-PWP to NEF 810, including all parameters contained in the TSR-PWP. This step corresponds 538 in FIG. 5. WTRU-2 may send a NAS message to AMF 804, indicating that this request should be forwarded to NEF 810 with the TSR-PWP included in an N1 container. AMF 804 may then use an appropriate Nnef-like message, such as Nnef_ServiceParameter, to forward the TSR-PWP to NEF 810. Alternatively, if direct communication with NEF 810 is supported, WTRU-2 may send the TSR-PWP directly to NEF.

At Step 846, NEF 810 may collect TSR-PWPs from other candidate TPs using the same process as 842 and 844. This step corresponds to 542 in FIG. 5.

At 848, NEF 810 may evaluate all received TSR-PWPs and identify a TTPG that satisfies at least one of two conditions: (1) all TSRs in the TSRP can be served, and (2) the TL-TR specified in the TSRP can be met. This step corresponds to 544 in FIG. 5.

At 850, if a DLF is implemented within UDM 806, NEF 810 may send a trust endorsements discovery request to UDM 806 using Nudm_SDM_Get, or to UDR 806 using Nudr_DM_Query, to verify trust potential declarations made by candidate TPs in the TTPG. This step corresponds to 546 in FIG. 5.

At 852, UDM/UDR 806 (or other NFs such as UDSF) may returns one or more trust endorsements to NEF 810. This step corresponds to 548 in FIG. 5.

At 854, NEF 810 may re-evaluate TPs in the TTPG and their TSR-PWPs, verifying which trust declarations are supported by credible trust endorsements received at 852. The TTPG may be transformed into an FTPG if at least one candidate TP can serve a TSR using an approved workload element. NEF 810 may also apply zero-trust principles to dynamically assess the latest trust status of TPs before finalizing the FTPG. This step corresponds to 550 in FIG. 5.

At 856, after creating an FTPG for TSR processing, NEF 810 may generate TSR sending policies for the TSR sender (AF/AS 812). This step corresponds to 552 in FIG. 5.

At 858, NEF 810 may notify each TP in the FTPG about approved workload assignments. Each TP may confirm its willingness to conduct TSR processing. This step corresponds to 554 in FIG. 5.

At 860, NEF 810 may record trust potential declarations associated with approved workload assignments in distributed ledgers non-repudiation commitments via UDM/UDR 806. This step corresponds to 556 in FIG. 5.

At 862 NEF 810 may send a request to PCF 808 using an appropriate Npcf-like message, such as a newly defined Npcf_TPGroupFormationAssistancePolicy_Create message, to register the created TSR sending policies at PCF 808. The request may include several parameters, such as the purpose of the request (e.g., registering the TSR sending policies and requesting PCF to enforce them), the identifiers of a set of TSR sending policies, the contents of the TSR policies, the involved task (e.g., Task-1), and the TSR sender(s) to whom the policies apply (e.g., AF/AS).

Alternatively, 856 may be performed by PCF 808 instead of NEF 810. In this case, 856, NEF 810 may send a request to PCF 808 using Npcf_AMPolicyControl_Create, which includes detailed information regarding the FTPG and TL-TR. PCF 808 may then gather additional data from other NFs, such as UDM/UDR 806, and based on the available information, create one or more TSR sending policies for the TSR sender to achieve the TL-TR. Once the TSR sending policies are created, PCF 808 may return them to NEF 810, which will then forward them to the TSR sender (AF/AS) 812 for enforcement. If PCF 808 generates the TSR sending policies, 762 and 764 may not be necessary.

At 864, PCF 808 may accept the TSR sending policies and may confirms to NEF 810 that these policies should be delivered to AF/AS 812 for enforcement.

At 866, based on the confirmation received at 864, NEF 810 may send the TSR sending policies to AF/AS 812. For example, if AF/AS 812 originally sent a TP group formation request to NEF 810 using the Nnef_TPGroupFormationAssistance_Subscribe service operation, NEF 810 may send a corresponding notification containing the TSR sending policies using the Nnef_TPGroupFormationAssistance_Notify service operation. Alternatively, if AF/AS 812 submitted the TP group formation request via an extension of an existing service operation for member UE selection in FL (such as Nnef_MemberUESelectionAssistance_Subscribe), NEF 810 may send a notification with the TSR sending policies using the existing Nnef_MemberUESelectionAssistance_Notify message.

At 868, AF/AS 812 may send an acknowledgment to NEF 810, confirming the receipt of the TSR sending policies.

At 870, AF/AS 812 may send TSRs to the FTPG based on the received TSR sending policies.

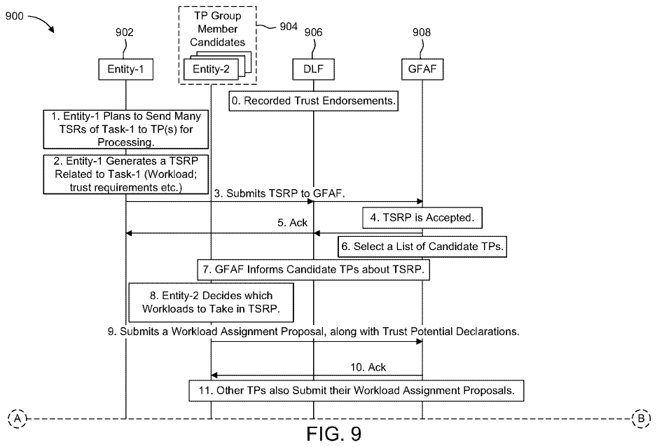

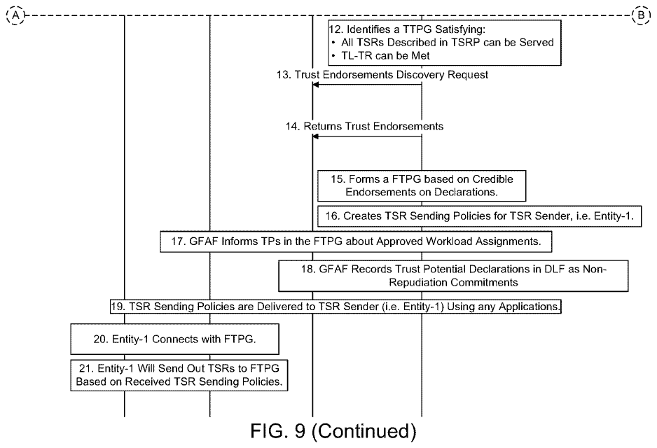

FIG. 9 illustrates an exemplary procedure 900 for trust-aware TP group formation in a non-3GPP network.

In a non-3GPP network, the role of a TSR sender (i.e., Entity-1 902), may be performed by any logical or physical entity, which may be located in various environments. For example, the entity may function in the field as a terminal device or gateway. Alternatively, the entity may be positioned within the infrastructure, such as a network node in the access network (e.g., a base station) or within the core network (e.g., NF). Additionally, the entity may reside in a data network or on the Internet (e.g., as an AS or AF). The TSR sender role may also not limited to 3GPP networks and may exist within any non-3GPP network infrastructure.

Similarly, the role of a TP (i.e., Entity-2 904) may be carried out by a logical or physical entity, located anywhere within a system. For example, the Entity-2 904 may operate in the field as a terminal device or gateway. Alternatively, it may be part of the infrastructure, such as a network node in the access network (e.g., a base station) or within the core network (e.g., an NF). It could also reside in a data network, on the Internet (e.g., as an AS/AF), or within non-3GPP network infrastructures.

In certain implementations, all 3GPP-specific NFs (e.g., AMF, PCF, UDM) may be removed, but their roles, functionalities, and related processing can still be realized within other systems where the proposed solution is deployed.

The DLF 906 and GFAF 908 may be introduced as functions or services within a non-3GPP platform or system. For example, the process for a trust-aware TP group formation may be implemented in a non-3GPP system such as an ETSI Permissioned Distributed Ledger (PDL) platform. In this scenario, a DLF may be integrated as a function within the existing Storage Platform Service of the ETSI PDL platform, while a GFAF may be implemented as a new function within the Application Registration Platform Service of the ETSI PDL platform.

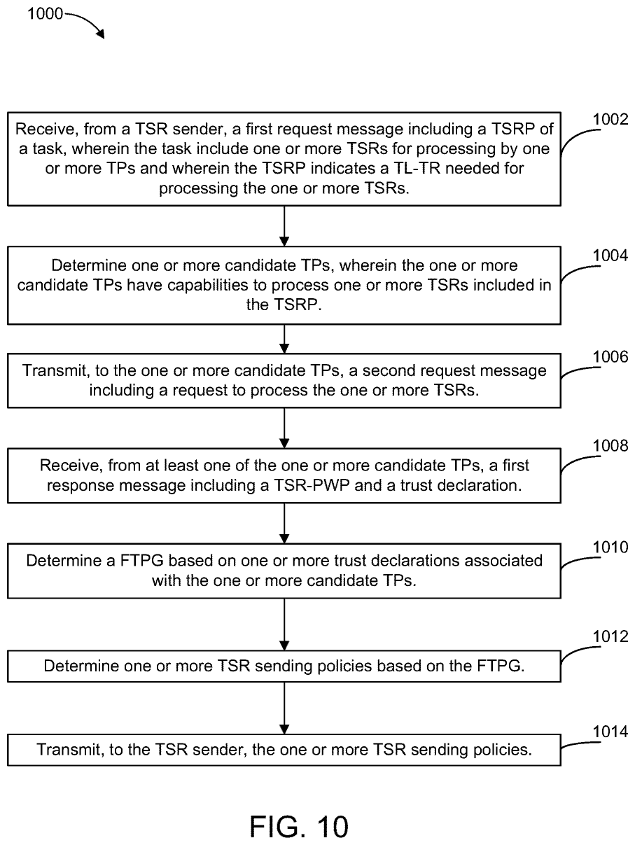

FIG. 10 illustrates an exemplary process performed by a NF for a trust-aware TP group formation. At 1002, the NF may receive, from a TSR sender, a first request message including a TSRP of a task, wherein the task include one or more TSRs for processing by one or more TPs and wherein the TSRP indicates a TL-TR needed for processing the one or more TSRs. At 1004, the NF may determine one or more candidate TPs, wherein the one or more candidate TPs have capabilities to process one or more TSRs included in the TSRP. At 1006, the NF may transmit, to the one or more candidate TPs, a second request message including a request to process the one or more TSRs. At 1008, the NF may receive, from at least one of the one or more candidate TPs, a first response message including a TSR-processing workload proposal (TSR-PWP) and a trust declaration. At 1010, the NF may, based on one or more trust declarations associated with the one or more candidate TPs, determine a FTPG. At 1012, the NF may determine, based on the FTPG, one or more TSR sending policies. At 1014, the NF may transmit, to the TSR sender, the one or more TSR sending policies.

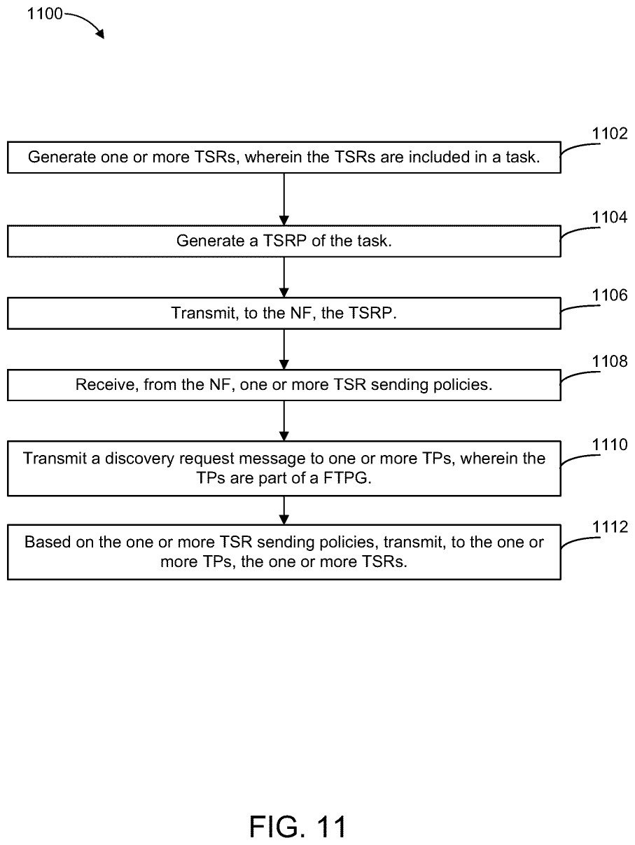

FIG. 11 illustrates an exemplary process performed by a TSR sender for a trust-aware TP group formation. At 1102, the TSR sender may generate one or more TSRs, wherein the TSRs are included in a task. At 1104, the TSR sender may generate a TSRP of the task. At 1106, the TSR sender may transmit, to a NF, the TSRP. At 1108, the TSR sender may receive, from the NF, one or more TSR sending policies. At 1110, the TSR sender may transmit a discovery request message to one or more TP, wherein the TPs are part of a FTPG. At 1112, based on the one or more TSR sending policies, the TSR sender may transmit, to the one or more TPs, the one or more TSRs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

What is claimed:

1. A method performed by a network function (NF), the method comprising:
receiving, from a task-specific request (TSR) sender, a first request message including a TSR profile (TSRP) of a task, wherein the task include one or more TSRs for processing by one or more task participants (TPs) and wherein the TSRP indicates a task-level trust requirement (TL-TR) needed for processing the one or more TSRs;
determining one or more candidate TPs, wherein the one or more candidate TPs have capabilities to process one or more TSRs included in the TSRP;
transmitting, to the one or more candidate TPs, a second request message including a request to process the one or more TSRs;
receiving, from at least one of the one or more candidate TPs, a first response message including a TSR-processing workload proposal (TSR-PWP) and a trust declaration;
based on one or more trust declarations associated with the one or more candidate TPs, determining a formal TP group (FTPG);
determining, based on the FTPG, one or more TSR sending policies; and
transmitting, to the TSR sender, the one or more TSR sending policies.

2. The method of claim 1, further comprising:
determining a tentative TP group (TTPG) based on the TSR-PWP, wherein the TTPG includes at least one of the one or more candidate TPs and is based on a trust potential declaration from at least one of the one or more candidate TPs;
transmitting, to a distributed ledger function (DLF), a third request message, including a trust endorsement discovery request; and
receiving, from the DLF, a second response message, including one or more trust endorsements associated with the one or more candidate TPs of the TTPG.

3. The method of claim 2, wherein the FTPG is determined from the TTPG based on the one or more trust endorsements of the one or more trust declarations.

4. The method of claim 2, wherein the third request message includes a trust endorsements discovery filter criteria.

5. The method of claim 1, wherein the NF is a group formation assistant function (GFAF).

6. The method of claim 1, wherein the TSR sender is a wireless transmit/receive unit (WTRU).

7. The method of claim 1, wherein the TSR-PWP indicates a workload assignment proposal.

8. The method of claim 1, wherein the TSRP includes one or more TSR-categories (TSR-Cs).

9. The method of claim 8, wherein each of the one or more TSR-Cs include at least one of a TSR-C identification, a TSR workload description, a TSR trust requirement, and a TSR-C importance score.

10. A network function (NF) configured to:
receive, from a task-specific request (TSR) sender, a first request message including a TSR profile (TSRP) of a task, wherein the task include one or more TSRs for processing by one or more task participants (TPs) and wherein the TSRP indicates a task-level trust requirement (TL-TR) needed for processing the one or more TSRs;
determine one or more candidate TPs, wherein the one or more candidate TPs have capabilities to process one or more TSRs included in the TSRP;
transmit, to the one or more candidate TPs, a second request message including a request to process the one or more TSRs;
receive, from at least one of the one or more candidate TPs, a first response message including a TSR-processing workload proposal (TSR-PWP) and a trust declaration;
based on one or more trust declarations associated with the one or more candidate TPs, determine a formal TP group (FTPG);
determine, based on the FTPG, one or more TSR sending policies; and
transmit, to the TSR sender, the one or more TSR sending policies.

11. The NF of claim 10, further configured to:
determine a tentative TP group (TTPG) based on the TSR-PWP, wherein the TTPG includes at least one of the one or more candidate TPs and is based on a trust potential declaration from at least one of the one or more candidate TPs;
transmit, to a distributed ledger function (DLF), a third request message, including a trust endorsement discovery request; and
receive, from the DLF, a second response message, including one or more trust endorsements associated with the one or more candidate TPs of the TTPG.

12. The NF of claim 11, wherein the FTPG is determined from the TTPG based on the one or more trust endorsements of the one or more trust declarations.

13. The NF of claim 11, wherein the third request message includes trust endorsements discovery filter criteria.

14. The NF of claim 10, wherein the NF is a group formation assistant function (GFAF).

15. The NF of claim 10, wherein the TSR sender is a wireless transmit/receive unit (WTRU).

16. The NF of claim 10, wherein the TSR-PWP indicates a workload assignment proposal.

17. The NF of claim 10, wherein the TSRP includes one or more TSR-categories (TSR-Cs).

18. The NF of claim 17, wherein each of the one or more TSR-Cs include at least one of a TSR-C identification, a TSR workload description, a TSR trust requirement, and a TSR-C importance score.

19. A task-specific request (TSR) sender configured to:
generate one or more task-specific requests (TSRs), wherein the TSRs are included in a task;
generate a task-specific request (TSR) profile (TSRP) of the task;
transmit, to a network function (NF), the TSRP;
receive, from the NF, one or more TSR sending policies;
transmit a discovery request message to one or more task participants (TPs), wherein the TPs are part of a formal TP group (FTPG);
based on the one or more TSR sending policies, transmit, to the one or more TPs, the one or more TSRs.

20. The TSR sender of claim 19, wherein the TSR sender is one of a wireless transmit/receive unit (WTRU), an application function (AF), or an application server (AS).
